(19) United States
(12) Patent Application Publication
(10) Pub. No.: US 2024/0403519 A1
(43) Pub. Date: Dec. 5, 2024

(54) SYSTEMS AND METHODS FOR DYNAMICALLY-CONSTRUCTED CLOUD-BASED REAL-TIME PRODUCTION DATA PROCESSING ENVIRONMENT SIMULATION

(71) Applicant: The Travelers Indemnity Company, Hartford, CT (US)

(72) Inventors: William K. Devine, Avon, CT (US); Emma J. Scopino, New Hartford, CT (US); Martin J. Grabeck, Wethersfield, CT (US); Sudeep Joseph, Charlotte, NC (US); Mike E. Robotham, Burlington, CT (US); Vinod Srinivasan, Avon, CT (US)

(21) Appl. No.: 18/329,531

(22) Filed: Jun. 5, 2023

(51) Int. Cl. G06F 30/27

(52) U.S. Cl. CPC G06F 30/27; G06F 2111/02

(57) ABSTRACT

Systems and methods for dynamically-constructed cloud-based real-time (and/or near-real-time) production data processing environment simulation.

### BACKGROUND

Data processing environments that support industry data intelligence and transactional throughput needs are often complex and expansive. Production systems are typically constructed utilizing many functionally-specific processing sub components, often sourced from different vendors, and include immense data storage platforms to capture and manage vast amounts of transactional data. The processing power and data storage requirement demands for such systems are great, and data processing-driven decision-making processes are highly-integrated and detailed. Accordingly, implementing changes in production-level decision-making processes is a complicated and resource-intensive task, which limits the ability of the system to adapt to changing needs. Similarly, the implementation of Artificial Intelligence (AI) modeling into the decision-making processes requires large amounts of processing power and data consumption in a system that is already heavily resource intensive.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2 is a block diagram of a system according to some embodiments;

FIG. 3A and FIG. 3B are block diagrams of a system according to some embodiments;

FIG. 4 is a flow diagram of a method according to some embodiments;

FIG. 5A and FIG. 5B are diagrams of example application interfaces according to some embodiments;

FIG. 6 is a block diagram of an apparatus according to some embodiments;

FIG. 7A, FIG. 7B, FIG. 7C, FIG. 7D, and FIG. 7E are perspective diagrams of exemplary data storage devices according to some embodiments; and

FIG. 8 is flowchart of an algorithm according to some embodiments.

### DETAILED DESCRIPTION

### I. Introduction

There are various scenarios in which the implementation of technology ecosystems in complex computing environments requires substantial time and resources to accomplish and for which errors in implementation can be costly to resolve. Many software-driven computing environments across various industries rely on large numbers of software applications and extensive amounts of stored data, for example, in which any individual change may cause unintended consequences. The level of interdependency between software applications, procedures, engines, and stored data throughout the environment is often so complex that many personnel with specialized knowledge are required to coordinate and understand even simple system changes. Changes to production systems that increase computational load and/or memory requirements can also dramatically (and unfavorably) impact the performance of production systems. Accordingly, any new processes or features must necessarily be implemented only after long, careful, and detailed implementation pathways have been traversed—which causes a long lead time prior to implementation in the production system.

In accordance with embodiments herein, these and other deficiencies of previous data processing systems are remedied by providing systems, apparatus, methods, and articles of manufacture for dynamically-constructed cloud-based real-time (and/or near-real-time) production data processing environment simulation. In some embodiments, a plurality of event listeners may monitor events occurring in production systems and/or subsystems, for example, process event data through an event exchange rule set, and utilize the processed event data and copies of stored data repositories to dynamically stand-up a cloud-based simulation environment.

The cloud-based simulation environment instance may have access to more plentiful processing power and/or data storage resources than the production environment and may accordingly be utilized to execute various models, processes, and/or procedures that would otherwise require too many resources to execute in the production environment itself. The additional costs for the cloud-based simulation environment instance may be transitory, as the simulation environment instance may be automatically broken down after use. In some embodiments, for example, a single simulation environment instance may be stood-up for each processing routine required for an event (or set of events) and may be automatically broken down after the particular processing event has been completed. The simulation environment instance may, according to some embodiments, be capable of being dynamically edited to test different models on production data (e.g., in real-time or near real-time) without jeopardizing the resources and/or data of the production environment.

### II. Dynamically-Constructed Cloud-Based Real-Time Production Data Processing Environment Simulation Systems

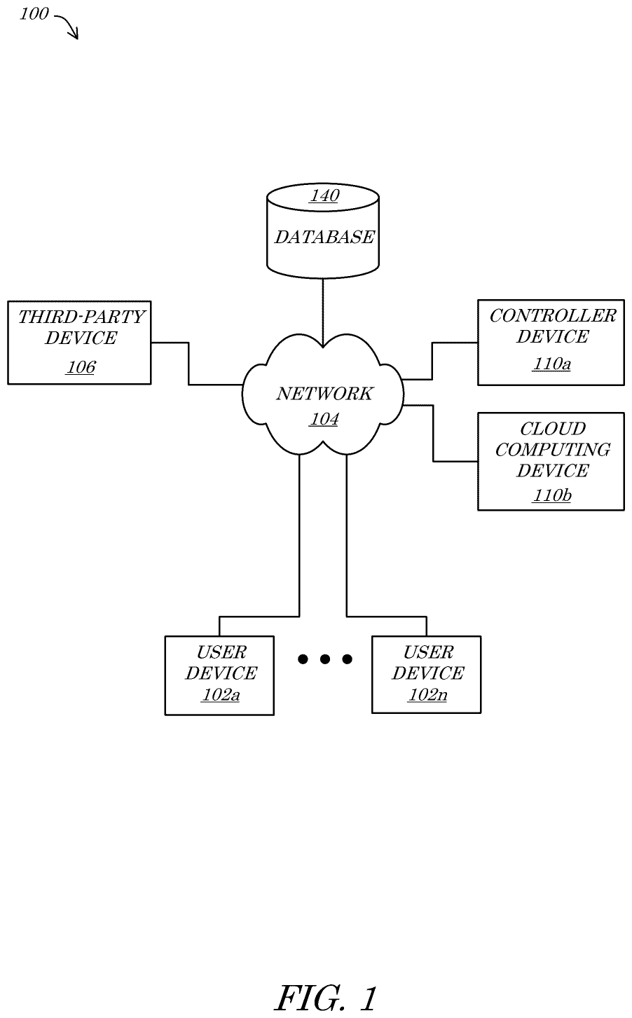

Referring first to FIG. 1, a block diagram of a system 100 according to some embodiments is shown. In some embodiments, the system 100 may comprise a plurality of user devices 102a-n in communication via or with a network 104. According to some embodiments, the system 100 may comprise a third-party device 106, a controller device 110a, and/or a cloud computing device 110b, e.g., any or all of which may be in communication with or via the network 104. In some embodiments, any or all of the devices 102a-n, 106, 110a-b may comprise and/or be in communication with a database, data storage device, and/or memory device 140. According to some embodiments, communications between and/or within the devices 102a-n, 106, 110a-b, 140 of the system 100 may be utilized to (i) identify production system events, (ii) classify and/or evaluate the production system events, (iii) trigger (e.g., based on one or more events) a standing-up of a cloud-based simulation environment instance, (iv) executing, via the cloud-based simulation environment instance, at least one data processing model/simulation, (v) computing (e.g., via the model/simulation) a response to the production system event(s), and/or (vi) publishing/outputting the computed response.

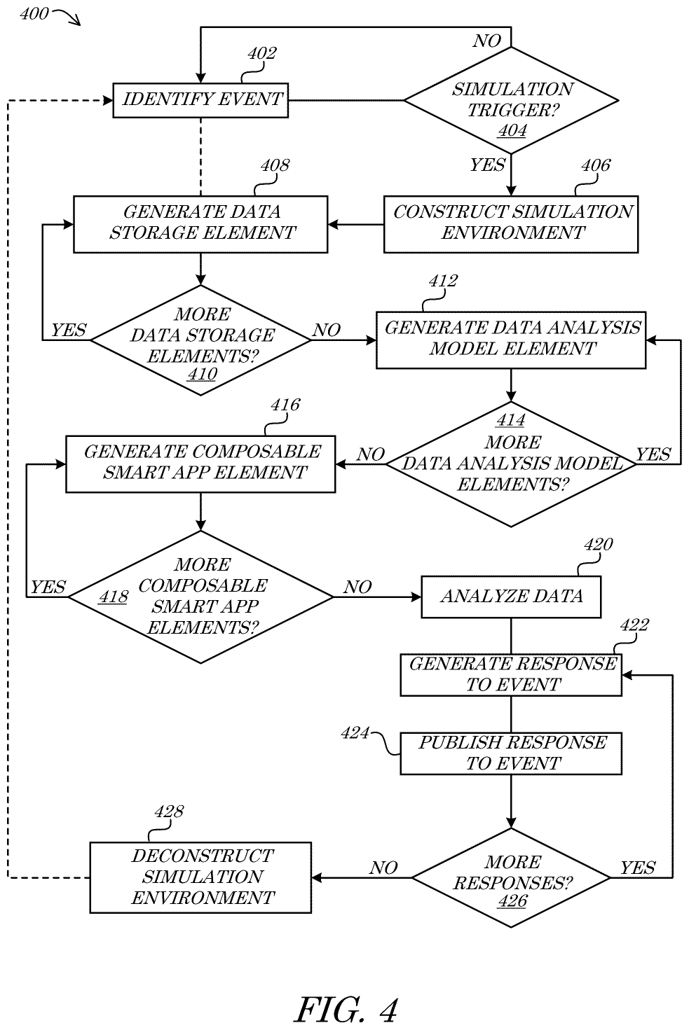

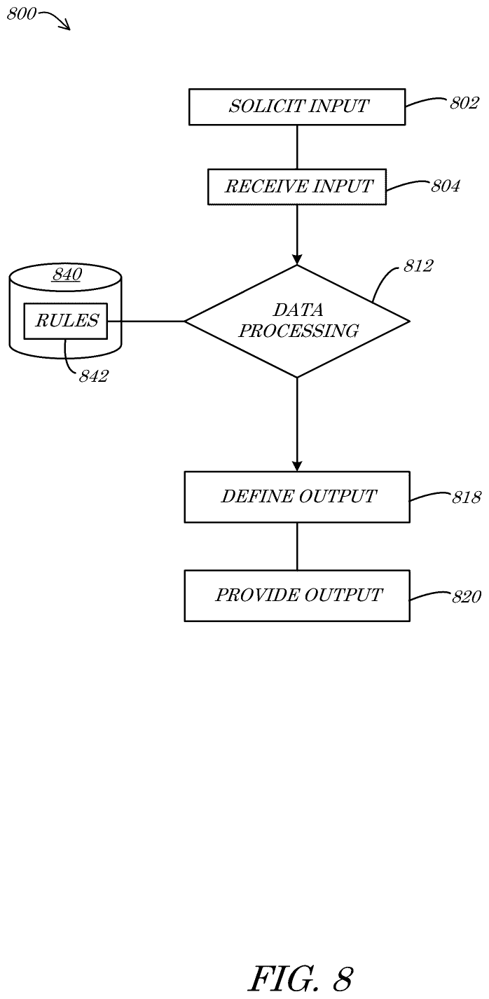

Fewer or more components 102a-n, 104, 106, 110a-b, 140 and/or various configurations of the depicted components 102a-n, 104, 106, 110a-b, 140 may be included in the system 100 without deviating from the scope of embodiments described herein. In some embodiments, the components 102a-n, 104, 106, 110a-b, 140 may be similar in configuration and/or functionality to similarly named and/or numbered components as described herein. In some embodiments, the system 100 (and/or portions thereof) may comprise a dynamically-constructed cloud-based real-time (and/or near-real-time) production data processing environment simulation system and/or a platform programmed and/or otherwise configured to execute, conduct, and/or facilitate the methods/algorithms 400, 800 of FIG. 4 and/or FIG. 8 herein, and/or portions or combinations thereof.

According to some embodiments, the user devices 102a-n may comprise any type or configuration of computing, mobile electronic, network, client, and/or communication devices that are or become known or practicable. The user devices 102a-n may, for example, comprise one or more Personal Computer (PC) devices, computer workstations, tablet computers, such as an iPad® manufactured by Apple®, Inc. of Cupertino, CA, and/or cellular and/or wireless telephones, such as an iPhone® (also manufactured by Apple®, Inc.) or an LG V50 THINQ™ 5G smart phone manufactured by LG® Electronics, Inc. of San Diego, CA, and running the Android® operating system from Google®, Inc. of Mountain View, CA. In some embodiments, the user devices 102a-n may comprise one or more devices owned and/or operated by one or more clients or customers (or potential customers; none of which are shown), such as users attempting to submit an application comprising various data elements to the controller device 110a (and/or an entity associated therewith, such as an insurance company; not shown), data analysts, insurance underwriters, insurance claims specialists, etc. According to some embodiments, the user devices 102a-n may communicate with the controller device 110a either directly or via the network 104 to automatically submit and/or evaluate an application, product request, account request, etc. In some embodiments, the cloud computing device 110b may be communicatively coupled to identify and/or intercept events, such as transaction events between the user devices 102a-n and the controller device 110a, e.g., to effectuate a dynamically-constructed cloud-based real-time (and/or near-real-time) production data processing environment simulation, as described herein.

The network 104 may, according to some embodiments, comprise a Local Area Network (LAN; wireless and/or wired), cellular telephone, Bluetooth®, Near Field Communication (NFC), and/or Radio Frequency (RF) network with communication links between the controller device 110a, cloud computing device 110b, the user devices 102a-n, the third-party device 106, and/or the memory device 140. In some embodiments, the network 104 may comprise direct communication links between any or all of the components 102a-n, 106, 110a-b, 140 of the system 100. The user devices 102a-n may, for example, be directly interfaced or connected to one or more of the controller device 110a and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The cloud computing device 110b may, for example, be connected to one or more of the user devices 102a-n via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110a-b, 140 of the system 100. The network 104 may comprise one or more cellular telephone networks with communication links between the user devices 102a-n and the controller device 110a, for example, and/or may comprise an NFC or other short-range wireless communication path, with communication links between various user devices 102a-n, for example.

According to some embodiments, the third-party device 106 may comprise any type or configuration of a computerized processing device, such as a PC, laptop computer, computer server, database system, and/or other electronic device, devices, or any combination thereof. In some embodiments, the third-party device 106 may be owned and/or operated by a third party (i.e., an entity different than any entity owning and/or operating either the user devices 102a-n, the controller device 110a, and/or the cloud computing device 110b; such as a certificate, authentication, and/or cryptographic service provider, and/or a satellite and/or other imagery and/or business or demographic data provider). The third-party device 106 may, for example, comprise a building, property, location, and/or demographics service and/or database repository that provides location, property, and/or map data for processing by the controller device 110a and/or the cloud computing device 110b. In some embodiments, the third-party device 106 may provide and/or transmit account or policy data, asset and/or object data (e.g., building data from municipal records), imagery and/or imagery analysis results data, tax and/or other business data, underwriting product claim and/or loss data, etc., to the controller device 110a, the cloud computing device 110b, and/or the user devices 102a-n. According to some embodiments, the third-party device 106 may comprise a plurality of devices (e.g., sensors and/or computing devices) and/or may be associated with a plurality of third-party entities. In some embodiments, the third-party device 106 may comprise the memory device 140 (or a portion thereof), such as in the case the third-party device 106 comprises a third-party data storage service, device, and/or system, such as the Amazon® Simple Storage Service (Amazon® S3™) available from Amazon.com, Inc. of Seattle, WA or an open-source third-party database service, such as MongoDB™ available from MongoDB, Inc. of New York, NY.

In some embodiments, the controller device 110a may comprise an electronic and/or computerized controller device, such as a computer server and/or server cluster communicatively coupled to interface with the user devices 102a-n and/or the third-party device 106 (directly and/or indirectly). The controller device 110a may, for example, comprise one or more PowerEdge™ M910 blade servers manufactured by Dell®, Inc. of Round Rock, TX, which may include one or more Eight-Core Intel® Xeon® 7500 Series electronic processing devices. According to some embodiments, the controller device 110a may be located remotely from one or more of the user devices 102a-n and/or the third-party device 106. The controller device 110a may also or alternatively comprise a plurality of electronic processing devices located at one or more various sites and/or locations (e.g., a distributed computing and/or processing network).

According to some embodiments, the controller device 110a may store and/or execute specially programmed instructions (not separately shown in FIG. 1) to operate in accordance with embodiments described herein. The controller device 110a may, for example, execute one or more programs, modules, models, and/or routines (e.g., production environment programs) that operate to process data in the furtherance of various procedures such as, but not limited to, insurance prospecting, application submission, underwriting product analysis, pricing, sales, issuance, renewal, and/or underwriting, and/or customer analysis.

In some embodiments, the cloud computing device 110b may comprise a plurality of communicatively coupled electronic and/or computerized processing devices, real and/or virtual, such as a plurality of servers. According to some embodiments, the cloud computing device 110b may comprise a conglomeration and/or mesh of interconnected, online processing resources that may either be dedicated or assigned ad hoc to the processing needs of the cloud computing device 110b. The cloud computing device 110b may comprise, for example, a processor-on-demand cloud computing service (and associated hardware), such as Amazon Web Services (AWS) offered by Amazon.com, Inc. of Seattle, WA. Activation, initiation, and/or scaling of the cloud computing device 110b may be dynamic, on-demand, pay-as-you-go, metered, and/or auto-scaled. According to some embodiments, the cloud computing device 110b may be located remotely from one or more of the user devices 102a-n, the controller device 110a, and/or the third-party device 106.

According to some embodiments, the cloud computing device 110b may store and/or execute specially programmed instructions (not separately shown in FIG. 1) to operate in accordance with embodiments described herein. The cloud computing device 110b may, for example, execute one or more programs, modules, models, and/or routines (e.g., Artificial Intelligence (AI) and/or Machine Learning (ML)) that facilitate the event-driven, non-production, real-time analysis of production system data, as described herein. According to some embodiments, the cloud computing device 110b may execute stored instructions, logic, and/or software modules and/or models to (i) identify production system events (e.g., by listening to communications between the user devices 102a-n and the controller device 110a and/or by monitoring the controller device 110a), (ii) classify and/or evaluate the production system events, (iii) trigger (e.g., based on one or more events) a standing-up of a cloud-based simulation environment instance (e.g., that may comprise and/or define the cloud computing device 110b, and/or a portion or component thereof), (iv) executing, via the cloud-based simulation environment instance (e.g., via the cloud computing device 110b), at least one data processing model/simulation, (v) computing (e.g., via the model/simulation) a response to the production system event(s), and/or (vi) publishing/outputting the computed response.

In some embodiments, the user devices 102a-n, the third-party device 106, the controller device 110a, and/or the cloud computing device 110b may be in communication with and/or comprise the memory device 140. The memory device 140 may comprise, for example, various databases and/or data storage mediums that may store, for example, asset and/or object data, account data, tax data, business data, image data, variable data, statistical data, sensor data, parameter value identification rules, object data, classification rules, keyword identification rules, GUI element data, natural text generation data, Optical Character Recognition (OCR) rules and/or data, cryptographic keys and/or data, login and/or identity credentials, and/or instructions (e.g., event exchange rules) that cause various devices (e.g., the controller device 110a, the cloud computing device 110b, the third-party device 106, and/or the user devices 102a-n) to operate in accordance with embodiments described herein.

The memory device 140 may store, for example, account, customer, and/or risk data as well as various Application Programming Interface (API) modules, applications, etc., each of which may, when executed, participate in, facilitate, and/or cause dynamically-constructed cloud-based real-time (and/or near-real-time) production data processing environment simulation, as described herein. In some embodiments, the memory device 140 may comprise any type, configuration, and/or quantity of data storage devices that are or become known or practicable. The memory device 140 may, for example, comprise an array of optical and/or solid-state hard drives configured to store digital image and/or video data, image and/or object analysis data, sensor data, business data, unstructured data, and/or deterministic model data (e.g., analysis formulas and/or mathematical models), credentialing instructions and/or keys, and/or various operating instructions, drivers, etc. In some embodiments, the memory device 140 may comprise a solid-state and/or non-volatile memory card (e.g., a Secure Digital (SD) card, such as an SD Standard-Capacity (SDSC), an SD High-Capacity (SDHC), and/or an SD extended-Capacity (SDXC) and any various practicable form factors, such as original, mini, and micro sizes, available from Western Digital Corporation of San Jose, CA. While the memory device 140 is depicted as a standalone component, the memory device 140 may comprise multiple components. In some embodiments, a multi-component memory device 140 may be distributed across various devices and/or may comprise remotely dispersed components. Any or all of the user devices 102a-n, the third-party device 106, the controller device 110a, and/or the cloud computing device 110b may comprise the memory device 140 or a portion thereof, for example.

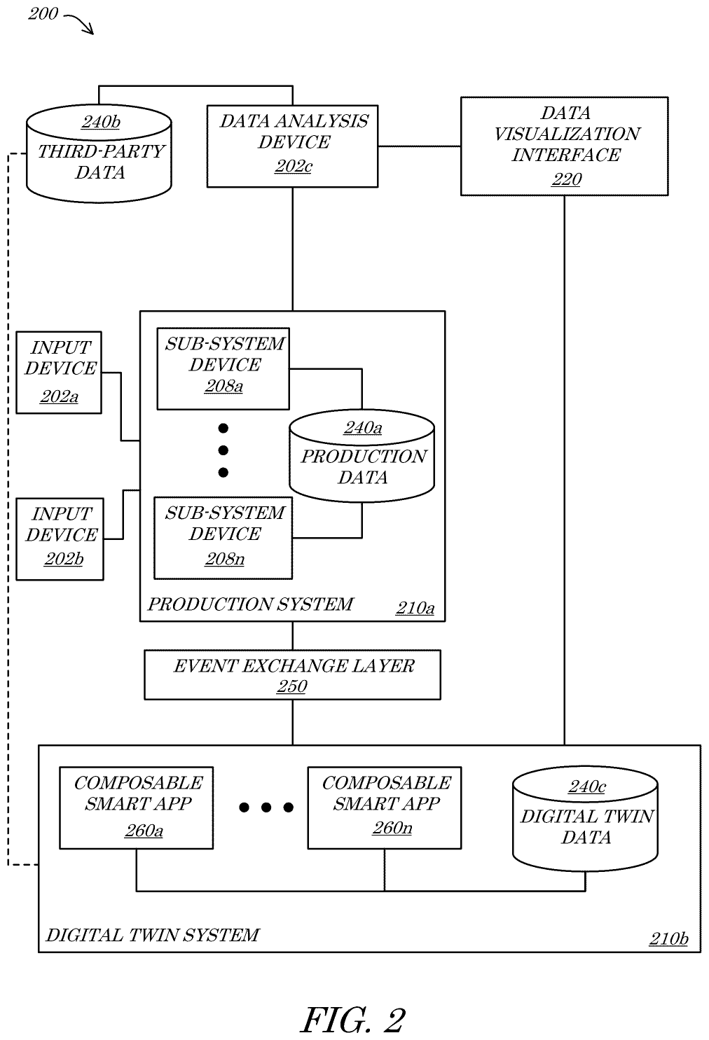

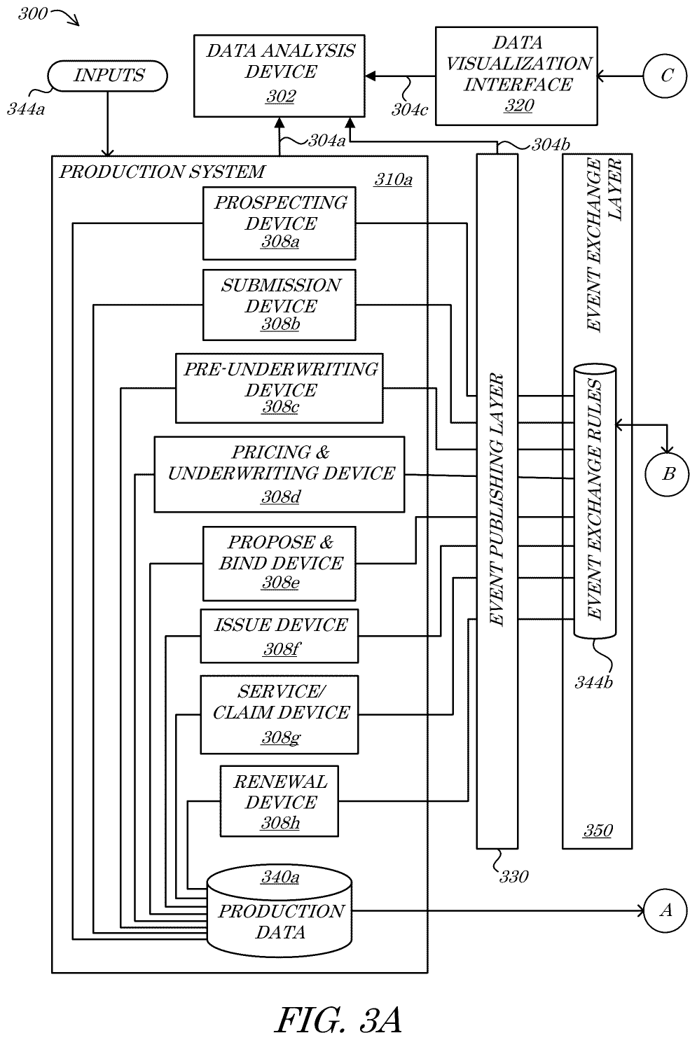

Turning to FIG. 2, a block diagram of a system 200 according to some embodiments, is shown. In some embodiments, the system 200 may comprise a system that enables dynamically-constructed cloud-based real-time (and/or near-real-time) production data processing environment simulation. The system 200 may comprise, for example, one or more input devices 202a-b and/or a data analysis device 202c that provide input to a plurality of subsystem devices 208a-n of a data processing production system 210a. According to some embodiments, the subsystem devices 208a-n may comprise any number and/or type of hardware, firmware, microcode, modules, models, and/or algorithms that are configured to process input data in one or more specific manners—e.g., to produce and/or define one or more output data elements. The production system 210a may, for example, be programmed to facilitate provision, processing, and/or access of input data (raw and/or processed by the subsystem devices 208a-n) received from the input devices 202a-b for consumption by the data analysis device 202c. The input devices 202a-b may be in communication with the production system 210a, for example, to provide and/or define various data elements, values, parameters, etc. In accordance with a non-limiting and ongoing example herein, the production system 210a may comprise an underwriting product system via which the data analysis device 202c may be utilized to analyze (e.g., risk, appetite, etc.), price, quote, issue, resolve claims for, and/or renew one or more underwriting product polices, applications, and/or accounts. In some embodiments, a digital twin system 210b may be utilized and/or employed to interface with the production system 210a and/or to define and/or provide a data visualization interface 220, e.g., to and/or via the data analysis device 202c. The data visualization interface 220 may be utilized, for example, to provide data analytic insights to the end-user.

In some embodiments, the digital twin system 210b may be coupled and/or configured to communicate with the production system 210a to gather information descriptive of production-level data processing operations. In the case that the production system 210a comprises an underwriting product data processing system, for example, the production system 210a may receive input via the input devices 202a-b, may operate upon the input by execution of the subsystem devices 208a-n, and/or may store production data (e.g., inputs, processed inputs, and/or outputs) in a production data store 240a. In some embodiments, the data analysis device 202c, e.g., in the normal course of production-level data processing, may access the production data store 240a to perform various data analytic operations. According to some embodiments, the data analysis device 202c may also or alternatively access (or have access to) a third-party data store 240b. The data analysis device 202c may access third-party data stored in the third-part data store 240b, for example, that comprises data different and/or in addition to the production data stored in the production data store 240a.

According to some embodiments, the digital twin system 210b may comprise a system configured (e.g., physically and/or communicatively structured and/or coupled, and/or programmed) to automatically copy, transform, and/or otherwise acquire and/or replicate production and/or third-party data stored in either or both of the production data store 240a and the third-party data store 240b. The digital twin system 210b may comprise, for example, a digital twin data store 240c in which production (and/or third-party) data is replicated—e.g., defining a “digital twin” of the production data (or a portion thereof). In some embodiments, the digital twin system 210b may comprise a system configured (e.g., physically and/or communicatively structured and/or coupled, and/or programmed) to automatically search for, query, identify, and/or otherwise determine (e.g., “listen” for, “harvest” or “mine”) event data from the production system 210a. The digital twin system 210b may, for example, (i) monitor, capture, and/or “listen” to events and/or data change events associated with (e.g., conducted by) the input devices 202a-b, the subsystem devices 208a-n, the production data store 240a, and/or the production system 210a, (ii) compare identified event and/or data parameters (e.g., updated data flags) to stored rules and/or criteria, and/or (iii) determine whether (e.g., based on an occurrence of a match and/or in-range reading) creation of a dynamically-constructed cloud-based real-time (and/or near-real-time) production data processing environment should be triggered based on the identified event(s)/data. In some embodiments, event data from the production environment may be received and/or acquired from an event exchange layer 250. The event exchange layer 250 may comprise logical hardware, firmware, and/or application (e.g., API) modules, for example, that act as listeners with respect to event data from the production system 210a. According to some embodiments, the event exchange layer 250 may comprise a listener (not separately shown) for each one of the subsystem devices 208a-n.

In some embodiments, such as in the case that a triggering event is identified (e.g., by the event exchange layer 250), the digital twin system 210b may be dynamically stood-up, initiated, and/or constructed. According to some embodiments, in the absence of a triggering event from production system 210a, the digital twin system 210b may not exist in the system 200. The digital twin system 210b may be generated and/or defined or constructed dynamically, for example, and then deconstructed or deleted, e.g., after processing in response to the triggering event has completed. As described herein, in such a manner the production system 210a may remain unaffected by the existence (or lack of existence) of the digital twin system 210b, and/or the digital twin system 210b may only temporarily consume non-production resources, e.g., to reduce cost and complexity.

According to some embodiments, the digital twin system 210b may process (e.g., utilizing one or more processing devices; not separately shown) event data (e.g., received from and/or via the event exchange layer 250) and/or stored data (e.g., data stored in the digital twin data store 240c) by utilizing one or more algorithms (e.g., instruction sets, modules, models, protocols, and/or programmatic engines) to execute and/or employ one or more composable smart applications 260a-n. The composable smart applications 260a-n may comprise API and/or other processing modules, models, and/or algorithm instances, for example, that are utilized to implement, execute, and/or apply one or more data processing and/or analysis models, such as AI, ML, graph, A/B testing, champion-challenger, and/or other regressive, logical, and/or computational models (e.g., a simulation) to data descriptive of a particular event, customer, account, product, etc. In some embodiments, the composable smart applications 260a-n may implement test AI/ML models and/or test mathematical equations and/or formulas, for example, to compute, calculate, generate, and/or otherwise derive or define a response, result, and/or outcome (e.g., of and/or to one or more events, such as a triggering event).

In some embodiments, in accordance with the non-limiting ongoing example of underwriting product data processing utilized herein, the composable smart applications 260a-n may process insurance data to compute a response to a customer inquiry. The customer inquiry may comprise, for example, a request for a quote, a submission of a claim, etc., while the response may comprise, e.g., an underwriting product quotation, offer, terms, claim handling decision, and/or policy renewal pricing. In such a manner, for example, the composable smart applications 260a-n and/or the digital twin system 210b may automatically implement test logic, rules, models, etc., against mirrored production data (e.g., from the production system 210a) without taxing the production system 210a. In some embodiments, the system 200 may provide the ability to simulate new logic, rules, models, etc., for a complex, established production system 210a with a variety of legacy subsystem devices 208a-n outside of the typically lengthy and costly new code implementation pathway for the production system 210a. In the case that changes to the simulation are desired, they may simply be coded into the event exchange layer 250 and/or the digital twin system 210b, such that a subsequent instance of the digital twin system 210b may be stood-up with the new code, without impacting the production system 210a.

Fewer or more components 202a-c, 208a-n, 210a-b, 220, 240a-c, 250, 260a-n and/or various configurations of the depicted components 202a-c, 208a-n, 210a-b, 220, 240a-c, 250, 260a-n may be included in the system 200 without deviating from the scope of embodiments described herein. In some embodiments, the components 202a-c, 208a-n, 210a-b, 220, 240a-c, 250, 260a-n may be similar in configuration and/or functionality to similarly named and/or numbered components as described herein. In some embodiments, the system 200 (and/or portions thereof) may comprise a dynamically-constructed cloud-based real-time (and/or near-real-time) production data processing environment simulation system and/or a platform programmed and/or otherwise configured to execute, conduct, and/or facilitate the methods/algorithms 400, 800 of FIG. 4 and/or FIG. 8 herein, and/or portions or combinations thereof.

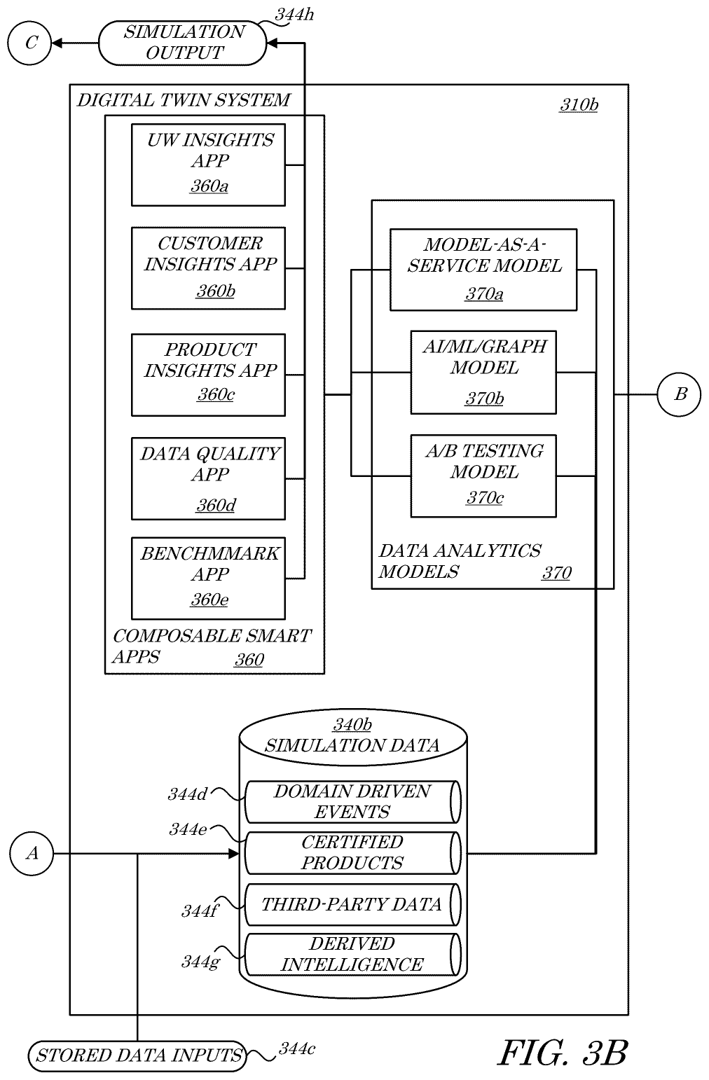

Referring now to FIG. 3A and FIG. 3B, block diagrams of a system 300 according to some embodiments, are shown. In some embodiments, the system 300 may comprise a system that that enables dynamically-constructed cloud-based real-time (and/or near-real-time) production data processing environment simulation. The system 300 may comprise, for example, a data analysis device 302 that is communicatively coupled to one or more communication pathways or channels 304a-c to receive, identify, query, obtain, access, and/or process data, e.g., with respect to a particular data processing goal, process, etc. In some embodiments, in accordance with the non-limiting ongoing example of underwriting product data processing utilized herein, the data analysis device 302 may be coupled via a first communication channel 304a to a production system 310a to process and/or evaluate underwriting product data to rate, quote, issue, sell, and/or renew an underwriting product policy. In some embodiments, the data analysis device 302 may communicate with a plurality of modules and/or devices 308a-h of the production system 310a to evaluate, e.g., an underwriting product transaction. According to some embodiments, the devices 308a-h may comprise any number and/or type of hardware, firmware, microcode, modules, models, and/or algorithms that are configured to process production data and provide various results, such as data trends, relationships, insights, etc. The production system 310a (and/or the devices 308a-h) may, for example, be programmed to facilitate provisioning, processing, and/or accessing underwriting product data for consumption by the data analysis device 302. According to some embodiments, such as depicted in FIG. 3A, the devices 308a-h may comprise: (i) a first or prospecting device 308a, (ii) a second or submission device 308b, (iii) a third or pre-underwriting device 308c, (iv) a fourth or pricing and underwriting device 308d, (v) a fifth or propose and bind device 308e, (vi) a sixth or issue device 308f, (vii) a seventh or service/claim device 308g, and/or (viii) an eighth or renewal device 308h.

In some embodiments, a digital twin system 310b may be utilized and/or employed to interface with the production system 310a (and/or the devices 308a-h) and/or to define and/or provide a data visualization interface 320, e.g., to and/or via the data analysis device 302. According to some embodiments, the production system 310a and the digital twin system 310b may be communicatively coupled to exchange event data. As depicted in FIG. 3A for example, the system 300 (and/or the production system 310a) may comprise and/or define an event publishing layer 330 that is in communication with each of the devices 308a-h. In some embodiments (as shown for non-limiting purposes of example), each of the devices 308a-h may be separately connected to and/or through the event publishing layer 330. Each of the devices 308a-h may, for example, comprise, define, and/or be paired and/or correlated with a separate and/or distinct event queue, application API, listener, publisher, parser, transmitter, and/or other event object (not separately shown). Transaction and/or other production events within the production system 310a may be communicated, in some embodiments, from any one or more of the devices 308a-h to the event publishing layer 330. In some embodiments, event data from the event publishing layer 330 may be transmitted to and/or accessed by the data analysis device 302, e.g., via a second communication channel 304b. The data analysis device 302 may, for example, ingest data from the devices 308a-h (e.g., via the first communication channel 304a) and the event publishing layer 330 (e.g., via the second communication channel 304b) to formulate a standard or “production” level response, result, and/or outcome—e.g., insurance claim denied, renewal price set to ‘x’ dollars, etc. According to some embodiments, the response/result may be at least partially derived based on data stored in a production data store 340a. In some embodiments, each of the devices 308a-h may be in communication with the production data store 340a. The devices 308a-h may, for example, access data from the production data store 340a to conduct data processing and/or store data in the production data store 340a (e.g., pre- or post-processing data). In some embodiments, the digital twin system 310b may copy and/or replicate the production data store 340a (or a portion thereof) via “A”, by creating, populating, and/or updating a simulation data store 340b. In some embodiments, the system 300 may comprise, define, and/or utilize various types, instances, values, and/or elements of data 344a-h. According to some embodiments, some or all of the data stored in the production data store 340a (and/or the simulation data store 340b), for example, may originate and/or be received from (or as) first data or inputs 344a. The inputs 344a may comprise, according to some embodiments, data from customers, third-party sources/vendors, agents, sensors, etc.

According to some embodiments (and with continued reference to FIG. 3A), the system 300 (and/or the digital twin system 310b) may comprise and/or define an event exchange layer 350 that is in communication with the event publishing layer 330. The event exchange layer 350 may comprise, for example, any number and/or type of hardware, firmware, microcode, modules, models, and/or algorithms that are configured to listen for, identify, receive indications of, access, intercept, and/or otherwise interface with event data of the event publishing layer 330 (and/or of or from any or all of the devices 308a-h). According to some embodiments, the event exchange layer 350 may comprise one or more “listener” devices (not separately shown) that are communicatively coupled to identify event data of the production system 310a. In some embodiments, as depicted in FIG. 3A for non-limiting purposes of example, each of the devices 308a-h may be separately and/or distinctly in communication with the event exchange layer 350 and/or a different “listener” (e.g., module, device, etc.) thereof. According to some embodiments, the event exchange layer 350 may comprise, define, and/or employ second data or event exchange rules 344b. The event exchange rules 344b may be evaluated upon identification of and/or with respect to any identified event (e.g., from the event publishing layer 330), in some embodiments, to determine any actions that should be effectuated by the digital twin system 310b in response to the event. The event exchange rules 344b may comprise and/or define, for example, various thresholds, criteria, logic, formulas, etc., that may be coded to filter, triage, and/or classify various production events, such as transactional events. In some embodiments, the event exchange layer 350 may comprise one or more processing devices (not separately shown) that execute and/or apply the event exchange rules 344b to automatically evaluate events identified by the event exchange layer 350. According to some embodiments, such as in the case that an event is identified as a triggering event, the event exchange layer 350 may trigger, e.g., via “B”, a standing-up of an instance of the digital twin system 310b.

In some embodiments, and with reference to FIG. 3B, the instance of the digital twin system 310b may comprise a plurality of composable smart applications 360, one or more data analytics models 370, and/or the simulation data store 340b. According to some embodiments, any or all of these components 340b, 360, 370 may be dynamically created, e.g., on demand, upon occurrence of a triggering event (e.g., as identified by the event exchange layer 350 and/or an application of the event exchange rules 344b thereof). In some embodiments, in accordance with the non-limiting ongoing example of underwriting product data processing utilized herein, the composable smart applications 360 may comprise one or more of (i) a first or underwriting insights application 360a, (ii) a second or customer insights application 360b, (iii) a third or product insights application 360c, (iv) a fourth or data quality application 360d, and/or (v) a fifth or benchmark application 360e. According to some embodiments, any or all of the composable smart applications 360 may be driven and/or informed by processing results from the data analytics model(s) 370. In some embodiments, the data analytics models 370 may comprise one or more of (i) a first or Model-as-a-Service (MaaS) model 370a, (ii) a second or AI/ML/graph model 370b, and/or (iii) a third or A/B testing model 370c. Any or all of the various data analytics models 370a-c may, in some embodiments, utilize third or stored data inputs 344c (e.g., from one or more external and/or third-party sources; not shown) and/or data from the simulation data store 340b, such as (i) fourth or domain driven event data 344d, (ii) fifth or certified product data 344e, (iii) sixth or third-party data 344f, and/or (iv) seventh or derived intelligence data 344g. In some embodiments, various data analytics models 370a-c may process stored data elements and/or values (e.g., data 344c-g) to derive, compute, and/or calculate one or more results, responses, outcomes, and/or metrics (e.g., data values) that are fed to and/or utilized by the various composable smart applications 360a-e. According to some embodiments, one or more of the composable smart applications 360a-e and/or one or more of the data analytics models 370a-c may operate upon the data 344c-g by executing specially-programmed models, logical, and/or mathematical routines to define eighth or simulation output data 344h. The simulation output data 344h may comprise, for example, a response, result, answer, outcome, and/or other value (quantitative and/or qualitative) derived, at least in part, on the triggering event and/or on stored data 344c-g having a predefined relationship with the triggering event. In the non-limiting example case of an underwriting product evaluation, for example, the simulation output data 344h may comprise an underwriting product risk metric computation/level, quotation price, underwriting decision (e.g., quote or issue a policy, or not), renewal pricing and/or underwriting decision, and/or a claims determination (e.g., cover a claimed loss, or not).

According to some embodiments, the simulation output data 344h may be transmitted and/or provided, e.g., via “C” (and with reference back to FIG. 3A), to and/or via the data visualization interface 320. In some embodiments, the data analysis device 302 may access and/or generate the data visualization interface 320, e.g., via a third communication channel 304c. The data analysis device 302 may, for example, output one or more production results, outcomes, responses, etc. (not separately shown), e.g., to a user (not shown) thereof, and may also (or alternatively) output the simulation output data 344h via the data visualization interface 320. In such a manner, for example, the data analysis device 302 may provide production data from (and/or derived from) the production system 310a along with and/or side-by-side with the simulation output data 344h from the digital twin system 310b. The user may be presented, accordingly, with both outcomes/results from a vetted/trusted production processing routine, as well as from a simulated/modeled environment for comparison. Such functionality affords greater flexibility to the user by presenting data results utilizing different techniques, without requiring disruption to the production system 310a. According to some embodiments, the instance of the digital twin system 310b may be broken down and/or deactivated after presentation of the simulation output data 344h, such that fewer additional processing and data resources (albeit, all non-production in nature) are utilized, which improves the processing efficiency of the system and reduces the costs of the simulation processes. Once the simulation output data 344h is consumed (e.g., upon receiving a command or request from the data analysis device 302 and/or via the data visualization interface 320, for example) any or all of the simulation data store 340b, the composable smart applications 360a-e, and/or the data analytics models 370a-c (and/or the overall digital twin system 310b) may be decommissioned, archived, deleted, broken down, deactivated, and/or otherwise turned off, e.g., removed from various processing and/or memory resource services and/or devices (not separately shown). Any or all cloud-based resources and/or services that are utilized to stand up the digital twin system 310b (and/or portions thereof), for example, may be turned off and/or decommissioned, e.g., dynamically upon conclusion of the simulation process for the one or more particular triggering events/transactions.

Fewer or more components 302, 304a-c, 308a-h, 310a-b, 320, 330, 340a-b, 344a-h, 350, 360, 360a-e, 370, 370a-c and/or various configurations of the depicted components 302, 304a-c, 308a-h, 310a-b, 320, 330, 340a-b, 344a-h, 350, 360, 360a-e, 370, 370a-c may be included in the system 300 without deviating from the scope of embodiments described herein. In some embodiments, the components 302, 304a-c, 308a-h, 310a-b, 320, 330, 340a-b, 344a-h, 350, 360, 360a-e, 370, 370a-c may be similar in configuration and/or functionality to similarly named and/or numbered components as described herein. In some embodiments, the system 300 (and/or portions thereof) may comprise a dynamically-constructed cloud-based real-time (and/or near-real-time) production data processing environment simulation system and/or a platform programmed and/or otherwise configured to execute, conduct, and/or facilitate the methods/algorithms 400, 800 of FIG. 4 and/or FIG. 8 herein, and/or portions or combinations thereof.

### III. Dynamically-Constructed Cloud-Based Real-Time Production Data Processing Environment Simulation Methods

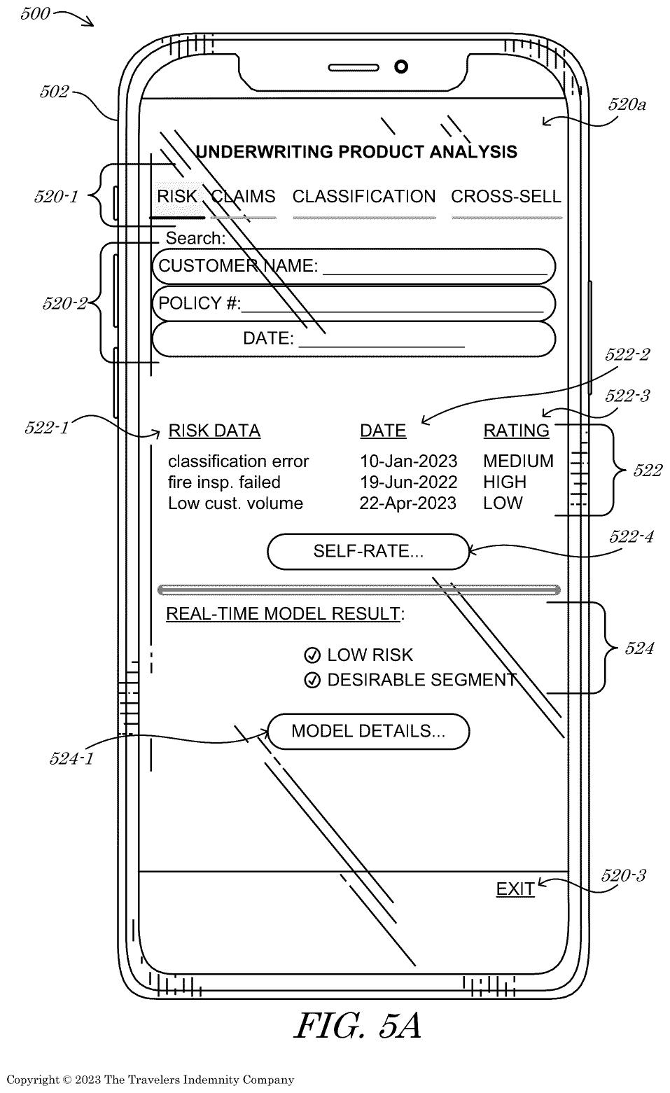

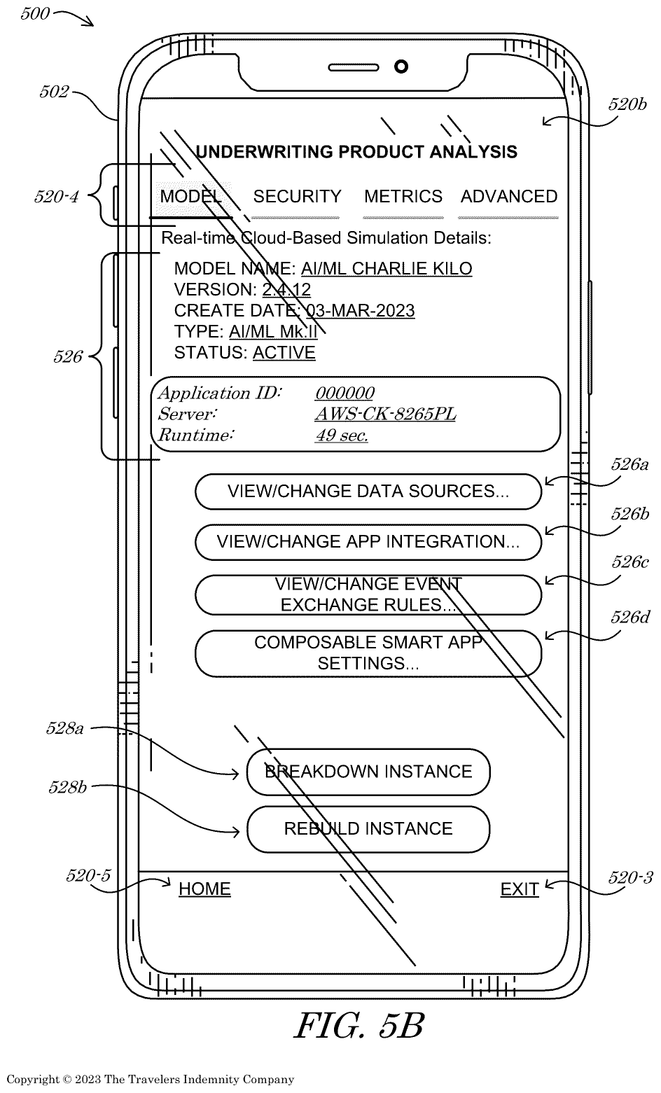

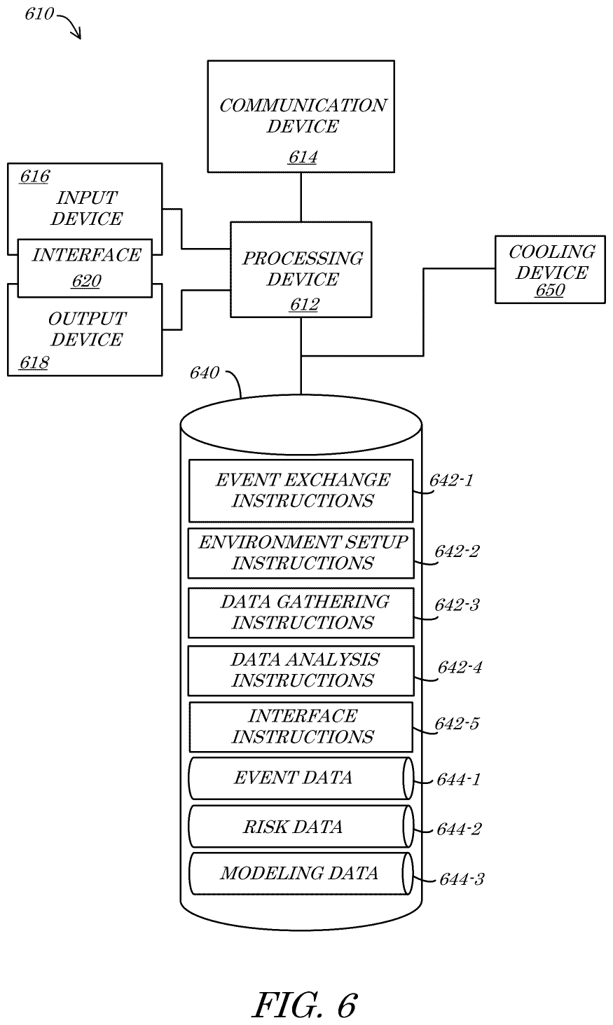

Referring now to FIG. 4, a flow diagram of a method 400 according to some embodiments is shown. In some embodiments, the method 400 may be performed and/or implemented by and/or otherwise associated with one or more specialized and/or specially-programmed computers (e.g., one or more of the user devices 102a-n, 202a-c, 302, the third-party device 106, the controller devices/production systems 110a, 210a, 310a, the cloud computing device/digital twin systems 110b, 210b, 310b and/or the apparatus 610 of FIG. 1, FIG. 2, FIG. 3A, FIG. 3B, and/or FIG. 6 herein), computer terminals, computer servers, computer systems and/or networks, and/or any combinations thereof (e.g., by one or more multi-threaded and/or multi-core processing units of a dynamically-constructed cloud-based real-time (and/or near-real-time) production data processing environment simulation system). In some embodiments, the method 400 may be embodied in, facilitated by, and/or otherwise associated with various input mechanisms and/or interfaces (such as the interfaces 220, 320, 520a-b, 620 of FIG. 2, FIG. 3A, FIG. 5A, FIG. 5B, and/or FIG. 6 herein).

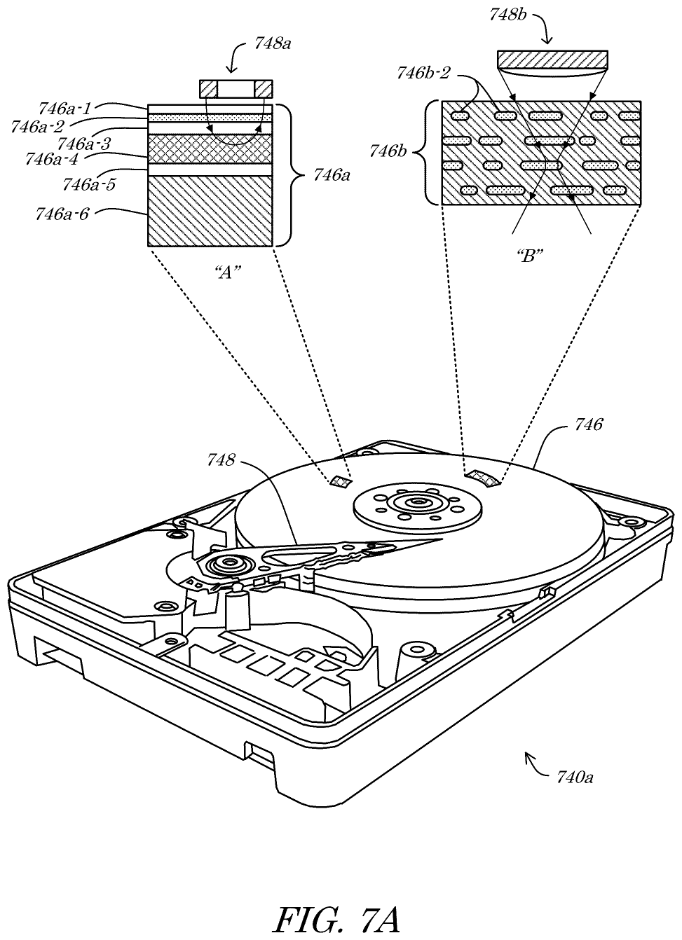

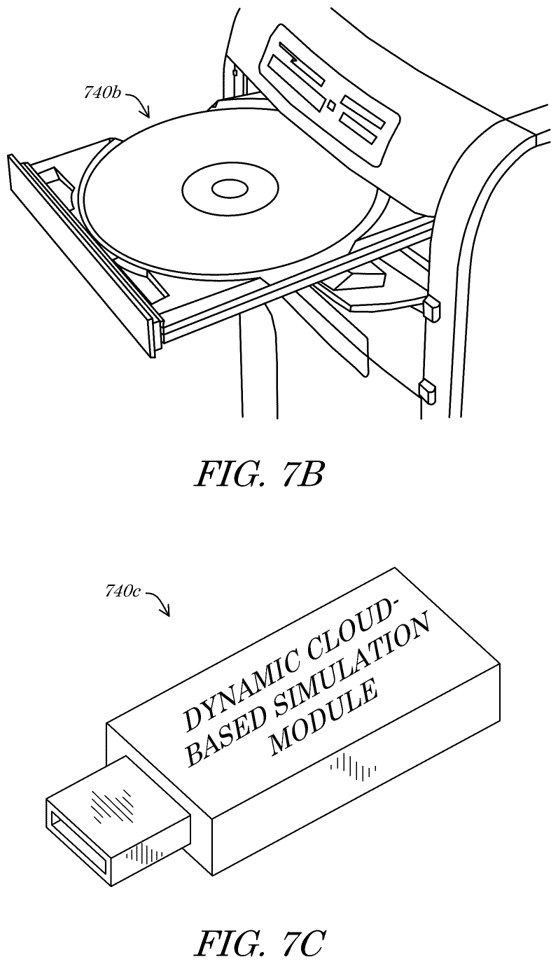

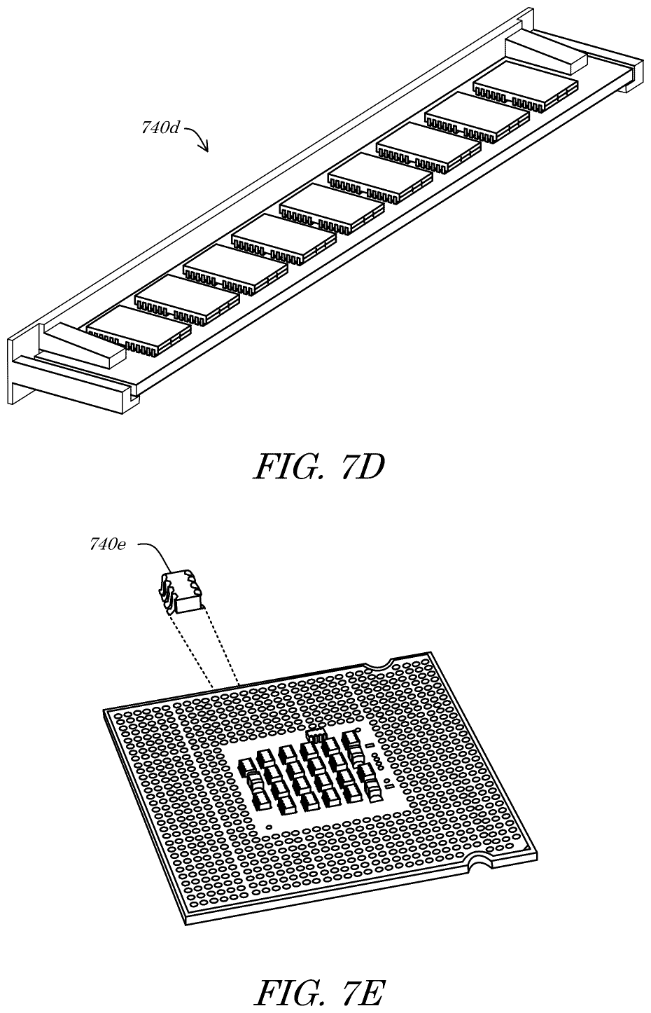

The process diagrams and flow diagrams described herein do not necessarily imply a fixed order to any depicted actions, steps, and/or procedures, and embodiments may generally be performed in any order that is practicable unless otherwise and specifically noted. Different depicted actions, steps, and/or procedures may be performed, unless specifically noted otherwise, in parallel or in series. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory/data storage devices 140, 240a-c, 340a-b, 640, 740a-e of FIG. 1, FIG. 2, FIG. 3A, FIG. 3B, FIG. 6, FIG. 7A, FIG. 7B, FIG. 7C, FIG. 7D, and/or FIG. 7E herein) may store thereon instructions that when executed by a machine (such as a computerized processor and/or electronic processing device) result in performance according to any one or more of the embodiments described herein.

In some embodiments, the method 400 may comprise identifying (e.g., by an electronic processing device, e.g., of an event exchange layer) an event, at 402. A non-production system and/or listener may, for example, monitor events and/or activity of a production-level data processing system to detect, identify, and/or intercept data indicative of and/or defining one or more events. In some embodiments, in accordance with the non-limiting ongoing example of underwriting product data processing utilized herein, the identifying may comprise an event exchange layer, device, and/or “listener” monitoring an event queue and/or communication pathway of one or more production-level systems, subsystems, devices, and/or modules/routines. According to some embodiments, a listener (device, module, etc.) may be programmed, e.g., with production system address, syntax, and/or API information, to listen for events from a particular subsystem, device, and/or module. Multiple listeners may be employed, for example, that are each dedicated to (e.g., specially-programmed and/or configured for) listening for events from a particular subsystem, device, and/or module of the production system.

According to some embodiments, the method 400 may comprise determining (e.g., by the electronic processing device, e.g., of the event exchange layer) whether an identified event comprises a dynamically-constructed cloud-based real-time (and/or near-real-time) production data processing environment simulation trigger, at 404. Input and/or received data identified (e.g., at 402) may be compared to stored thresholds, rules, and/or criteria, for example, to determine whether the identified event/data comprises a trigger for dynamic/real-time, non-production system simulation. The event/trigger may comprise, for example, an occurrence of a particular scheduled time, a passing of a particular period of time, a receipt of a particular type, quantity, and/or value of input (e.g., a command or request), a transactional status flag change, a communication event with a customer/client, etc. In some embodiments, a match between the event and stored data (e.g., a direct comparison match, an above or below threshold match, and/or a match of a value falling within a predetermined range of values) may indicate a trigger condition, while a lack of a match may indicate that a triggering event has not occurred. In the case that it is determined that a triggering event has not occurred, the method 400 may continue, proceed back to, and/or comprise identifying a new event, at 402. The method 400 may, for example, “listen” for and/or otherwise monitor one or more event and/or input sources to identify event occurrences, e.g., until a triggering event is identified, at 404.

In some embodiments, such as in the case that a triggering event is identified at 404, the method 400 may comprise and/or continue, to construct (e.g., stand up; by the electronic processing device, e.g., of the event exchange layer) a simulation environment, at 406. The event exchange layer may call one or more modules, models, routines, and/or invoke one or more cloud computing resources, for example, to initiate the construction of a dynamic instance of a cloud-based simulation environment—e.g., a “digital twin”. The dynamically-created simulation environment may comprise a plurality of components, processing power allocations (e.g., virtual servers), memory storage space allocations (e.g., distributed data store resources), and/or one or more dynamically-constructed and/or invoked data processing and/or analysis models, engines, and/or applications (e.g., one or more composable API objects). According to some embodiments, the event exchange layer may call, invoke, and/or initiate the simulation environment construction, e.g., based on and/or in response to the determination of a triggering event and/or condition, at 404. In some embodiments, based on the nature of the triggering event/input, only a subset of the simulation environment components may be called, activated, constructed, and/or invoked.

According to some embodiments, the method 400 may comprise generating (e.g., by the electronic processing device, e.g., of the event exchange layer and/or of a cloud computing environment/instance) a cloud-based data storage element, at 408. The creation of the simulation environment may, for example, comprise initiating, allocating, defining, and/or otherwise establishing a cloud-based data storage structure (e.g., table, schema, database, table space, etc.). In some embodiments, one or more data sources may be identified and mirrored and/or replicated to define the data storage element. Data and/or data structures of the production system may be copied, mirrored, and/or replicated, for example, and/or one or more third-party (e.g., external) data elements and/or structures may also or alternatively be copied, mirrored, and/or replicated. According to some embodiments, data may be loaded into and/or populated within the data storage element. While the data storage element may be dynamically created, as production data may be voluminous, a historic and/or previous copy/instance of a copy of production data may be stored, be persistent (e.g., not dynamically broken down), and/or may otherwise be utilized as a starting point for the creation of the data storage element, and cumulative data differences (e.g., new data) may be copied/replicated, e.g., to reduce processing time in creating the data storage element.

In some embodiments, the method 400 may comprise determining (e.g., by the electronic processing device, e.g., of the event exchange layer and/or of the cloud computing environment/instance) whether additional data storage elements remain to be generated, at 410. Each data storage element identified for the production system and/or from a third-party data source may, for example, be flagged for copying/replication, or a subset of such data elements may be flagged and/or identified (e.g., by application of stored rules, preferences, etc.). In the case that it is determined that more data storage elements remain (e.g., not all data storage elements have been copied/replicated), the method 400 may continue to and/or loop back to generating an additional data element at 408. In the case that all data storage elements have been generated (e.g., copied/replicated), the method 400 may comprise and/or continue to generating (e.g., by the electronic processing device, e.g., of the event exchange layer and/or of a cloud computing system) a cloud-based data analysis model element, at 412.

According to some embodiments, a data analysis model element may be generated by executing a creation script and/or loading a software module, model, and/or procedure, e.g., into the cloud computing environment/instance. In some embodiments, a listing and/or repository of data identifying and/or defining a plurality of available (e.g., precoded and/or predefined) data analysis model elements may be identified, accessed, and/or queried. According to some embodiments, user input may be solicited to select/choose one or more data analysis model elements from the plurality of elements. The data analysis model element may comprise, for example, a particular AI, ML, graph, mathematical, regression, logical, and/or other analytical model, formula, rule set, criteria, and/or algorithm from the plurality of data analysis model elements. In some embodiments, the data analysis model element may comprise a particular version of an AI model (such as an AI risk analysis model), for example. According to some embodiments, the data analysis model element may comprise instructions, pointers, and/or precoded elements that identify particular data storage elements, variables, tables, arrays, files, etc., that the data analysis model element may utilize to compute and/or calculate one or more data processing results, responses, outcomes, etc. In some embodiments, such as in the case that the data analysis model element comprises an AI/ML model, the model may be pretrained and simply reactivated and/or stood up as a live/active instance/module/model/procedure. According to some embodiments, in accordance with the non-limiting ongoing example of underwriting product data processing utilized herein, the data analysis model element may comprise an AI/ML, graph, A/B testing, and/or other model and/or programmed selective strategy that is operable to provide a determination, such as a response, result, and/or outcome (e.g., automatically) regarding an underwriting product, account, product, quotation, claim determination, etc.

In some embodiments, the method 400 may comprise determining (e.g., by the electronic processing device, e.g., of the event exchange layer and/or of the cloud computing environment/instance) whether additional data analysis model elements remain to be generated, at 414. Each data analysis model element identified from the plurality of available/predefined data analysis model elements may, for example, be flagged for building/generation (e.g., by application of stored rules, preferences, etc.). In the case that it is determined that more data analysis model elements remain (e.g., not all data analysis model elements have been generated/built), the method 400 may continue to and/or loop back to generating an additional data analysis model element at 412. In the case that all data analysis model elements have been generated (e.g., built, activated), the method 400 may comprise and/or continue to generating (e.g., by the electronic processing device, e.g., of the event exchange layer and/or of the cloud computing environment/instance) a cloud-based composable smart application element, at 416.

According to some embodiments, a composable smart application element may be generated by executing a creation script and/or loading a software module, API, and/or procedure, e.g., into the cloud computing environment/instance. In some embodiments, a listing and/or repository of data identifying and/or defining a plurality of available (e.g., precoded and/or predefined) composable smart application elements may be identified, accessed, and/or queried. According to some embodiments, user input may be solicited to select/choose one or more composable smart application elements from the plurality of elements. The composable smart application element may comprise, for example, a particular programmatic routine, algorithm, and/or tool that provides a predefined functionality with respect to, e.g., one or more of the data storage elements and/or data stored therein. According to some embodiments, the composable smart application element may comprise a data visualization and/or analysis tool that provides one or more results, responses, outcomes, values, etc., from one or more of the data analysis model elements, e.g., in a form that is consumable by an end-user. In some embodiments, in accordance with the non-limiting ongoing example of underwriting product data processing utilized herein, the composable smart application element may receive an underwriting product and/or transactional outcome and/or value from a data analysis model element, such as an AI model, for example, and provide (e.g., generate and/or define) one or more interface output elements that are presented to (and/or accessible to) a user. In accordance with some embodiments, for example, the composable smart application element may provide and/or suggest an underwriting product determination to the user, such as, but not limited to: approve underwriting, deny underwriting, approve risk, avoid risk, quote and/or sell an underwriting product for a particular value (or range of values), renew a policy, deny renewal of a policy, set product/policy terms (new and/or renewal) to certain values (or ranges of values), approve/pay claim, deny claim, etc.

In some embodiments, the method 400 may comprise determining (e.g., by the electronic processing device, e.g., of the event exchange layer and/or of the cloud computing environment/instance) whether additional composable smart application elements remain to be generated, at 418. Each composable smart application element identified from the plurality of available/predefined composable smart application elements may, for example, be flagged for building/generation/activation (e.g., by application of stored rules, preferences, etc.). In the case that it is determined that more composable smart application elements remain (e.g., not all composable smart application elements have been generated/built/activated), the method 400 may continue to and/or loop back to generating an additional composable smart application element at 416. In the case that all composable smart application elements have been generated (e.g., built, activated), the method 400 may comprise and/or continue to analyzing (e.g., by the electronic processing device, e.g., of the event exchange layer and/or of the cloud computing environment/instance) data, at 420.

According to some embodiments, the analyzing of the data may comprise executing an instance of one or more of the data analysis model elements. Data stored in one or more of the data storage elements may be accessed and/or utilized (e.g., as inputs) by one or more data analysis model elements, for example, to compute, calculate, derive, and/or define one or more values for one or more variables by generating one or more result, outcome, and/or response variable values, at 422. In some embodiments, the applied data analysis model element(s) may provide a plurality of outcome, response, and/or result values to one or more of the composable smart application elements. The composable smart application elements may, in some embodiments, provide and/or output indications of any or all of the plurality of outcome, response, and/or result values to an end-user, by publishing the values (e.g., event responses/determinations), at 424. In some embodiments, in accordance with the non-limiting ongoing example of underwriting product data processing utilized herein, the analyzing of the data (e.g., by executing the data analysis model elements and/or the composable smart application elements based on data stored in the data storage elements) may comprise providing an underwriting product determination, such as a recommendation regarding whether a risk level for a policy is too high, what the value of a quoted premium should be, and/or what level of a deductible should be set for a policy renewal.

In some embodiments, the method 400 may comprise determining (e.g., by the electronic processing device, e.g., of the event exchange layer and/or of the cloud computing environment/instance) whether additional outcomes, responses, and/or result values remain to be generated, at 426. Each composable smart application element and/or data analysis model element may comprise and/or identify (e.g., including a listing of) outcomes, responses, and/or result values that may be computed, for example, and any or all of such data elements/values may be flagged for building/generation/activation (e.g., by application of stored rules, preferences, etc.). In the case that it is determined that more outcomes, responses, and/or result values remain (e.g., not all outcomes, responses, and/or result values have been computed/generated), the method 400 may continue to and/or loop back to generating an additional outcome, response, and/or result value at 422. In the case that all outcomes, responses, and/or result values have been generated (e.g., generated, computed, calculated, looked up), the method 400 may comprise and/or continue to deconstructing (e.g., by the electronic processing device, e.g., of the event exchange layer and/or of the cloud computing environment/instance) the cloud-based simulation environment/instance, at 428.

In response to completion of the data analysis at 420, the generation of outcomes/responses/values at 422, the publishing of the outcomes/responses/values at 424, and/or in response to input received from the end-user and/or the production environment (e.g., an indication that a particular transaction associated with the triggering event has concluded), for example, any or all components of the dynamic instance of the cloud-based simulation environment (the digital twin) may be deactivated, deconstructed, broken down, deleted, etc. In some embodiments, feedback data (e.g., from the end-user and/or based on the computed outcomes/responses/values) may be stored and/or utilized to modify and/or enhance the underlying build instructions for the simulation environment, e.g., prior to deconstruction. Data indicative of whether the end-user accepted and/or adopted a computed/published recommendation, for example, may be utilized to update the code and/or training for one or more of the data analysis model elements, the composable smart application elements, and/or the data storage elements. According to some embodiments, the deconstruction at 428 may comprise taking cloud-based processing power and/or allocated data storage capacity offline. In such a manner, for example, the simulation environment may only exist (or fully exist) on an as-needed basis triggered by production system events and may otherwise be decommissioned to save cost and resources. In some embodiments, as indicated by the dotted line in FIG. 4, the method 400 may repeat and/or loop back to identifying additional events at 402 after deconstruction at 428. In such a manner, for example, the method 400 may continually monitor production system events and dynamically construct instances of the simulation environment in response to triggering events (e.g., events coded to warrant the ad hoc decision-making/data processing functionality of the simulation environment). According to some embodiments, the method 400 may be replicated to occur in multiple simultaneous instances. In other words, multiple different/distinct simulation environments may be simultaneously constructed, utilized, and broken down, in parallel, as dictated by a flow of identified triggering events in the production system. In some embodiments, such as in the case that an instance of the simulation environment is already stood-up, additional events (e.g., other than a triggering event) may be processed by and/or through the simulation environment, e.g., as indicated by the dotted line proceeding from 402 to 408 in FIG. 4. Once triggered/built, for example, a simulation environment instance may process a plurality of events, e.g., identified at 402.

### IV. Dynamically-Constructed Cloud-Based Real-Time Production Data Processing Environment Simulation Interfaces

Referring now to FIG. 5A and FIG. 5B, diagrams of a system 500 depicting a user device 502 providing instances of example application interfaces 520a-b according to some embodiments are shown. In some embodiments, the interfaces 520a-b may comprise application/API interface screens, web pages, web forms, database entry forms, API instances, spreadsheets, tables, and/or data visualization and/or analysis applications or other GUI instances via which a user may utilize production system and digital twin data, as described herein. The interfaces 520a-b may, for example, comprise a front-end of a dynamically-constructed cloud-based real-time (and/or near-real-time) production data processing environment simulation system and/or platform programmed and/or otherwise configured to execute, conduct, and/or facilitate the methods/algorithms 400, 800 of FIG. 4 and/or FIG. 8 herein, and/or portions or combinations thereof. In some embodiments, interfaces 520a-b may be output via a computerized device, such as the user device 502, which may, for example, be in communication with one or more of the third-party device 106, the controller devices/production systems 110a, 210a, 310a, the cloud computing device/digital twin systems 110b, 210b, 310b and/or the apparatus 610 of FIG. 1, FIG. 2, FIG. 3A, FIG. 3B, and/or FIG. 6 herein. The interfaces 520a-b may, as depicted for example, comprise underwriting product evaluation/analysis data representations output via the user device 502, which may comprise various graphical representations, mappings, and/or interface/input elements.

According to some embodiments, the interfaces 520a-b may comprise one or more tabs and/or other segmented and/or logically-presented data forms and/or fields. In some embodiments, the interfaces 520a-b may be configured and/or organized to allow and/or facilitate visualization and/or interaction with a combination of production data and “digital twin” data. In some embodiments, a first version (or page, instance, orientation, view, and/or aspect) of the interface 520a, as depicted in FIG. 5A, may comprise a first visualization that comprises a menu 520-1, a search input area 520-2, an “exit” button/link 520-3, a production data listing 522 (e.g., comprising risk data 522-1, date data 522-2, and/or rating data 522-3, and/or a “self-rate . . . ” button 522-4), and/or digital twin data output 524 (e.g., comprising a “model details . . . ” button 524-1).

In some embodiments, the menu 520-1 may be utilized to select a particular subsystem and/or environment for analysis, e.g., the “RISK” tab depicted as having been selected in FIG. 5A, a “CLAIMS” tab, a “SIC” tab, and/or a “RECEIPTS” tab. According to some embodiments, within any particular subsystem/environment/area, the user may search to identify any customers, accounts, products, assets, policies, etc., utilizing the search input area 520-2. In some embodiments, the production data listing 522 may provide identifying and/or event-level details representing any searched and/or otherwise presented entities, assets, objects, etc. As depicted in FIG. 5A, for example, the first version of the interface 520a and/or the respective production data listing 522 may provide detailed data descriptive of an entity, asset, policy, and/or other object's risk (522-1), date (e.g., of the data event; 522-2), and/or a production system-determined rating (e.g., a risk rating computed by production-level processing systems; 522-3). In some embodiments, the user may access and/or select the “self-rate . . . ” button 522-4 to enter a user-defined analysis based, e.g., on the data provided in the production data listing 522.

According to some embodiments, the digital twin data output 524 may comprise an output area where one or more outcomes, responses, and/or result values computed/provided by a digital twin system are provided to the user. As depicted in FIG. 5A, for example, the user may be presented with suggestions based on real-time digital twin/simulation model results, such as determinations that the selected asset, policy, application, and/or object is “low risk” and that it falls within a “desirable segment”, e.g., of an underwriting business portfolio. In some embodiments, the user may take this simulation data into account by basing a user decision on the digital twin data output 524. According to some embodiments, the user may select and/or activate the “model details . . . ” button 524-1 to access and/or edit details of the digital twin system.

In some embodiments, for example, a second version (or page, instance, orientation, view, and/or aspect) of the interface 520b, as depicted in FIG. 5B, may comprise the exit button/link 520-3, a digital twin menu 520-4, a “home” button/link 520-5, a model/simulation environment details data listing 526, various model action buttons/options 526a-d, and/or various simulation environment action buttons/options 528a-b. The digital twin menu 520-4 (and/or the second version of the interface 520b) may be generated and/or output, for example, in response to receiving user input via the “model details . . . ” button 524-1. In some embodiments, the digital twin menu 520-4 may be utilized to select a particular type of detailed information to view, e.g., the “MODEL” tab depicted as having been selected in FIG. 5B, a “SECURITY” tab, a “METRICS” tab, and/or an “ADVANCED” tab. According to some embodiments, within any particular type of detailed information to view, detailed data may be output via the second version of the interface 520b (and/or additional versions, not shown).

According to some embodiments, the model/simulation environment details data listing 526 may provide detailed data descriptive of a particular model (e.g., an AI/ML/graph and/or other mathematical and/or logical simulation model, such as one or more of the data analytics models 370 of FIG. 3B herein) that has been selected by the user and/or utilized to provide and/or define the digital twin data output 524. In some embodiments, activation of (i) a first or “View/Change data sources . . . ” button 526a may permit the user to view/edit types and/or sources of data (e.g., one or more of the elements of data 344c-g stored by the simulation data store 340b of FIG. 3B herein) utilized by the model, (ii) a second or “View/Change app integration . . . ” button 526b may permit the user to add or remove any applications and/or interfaces (e.g., one or more of the composable smart apps 360 and/or the data visualization interface 320 of FIG. 3A and/or FIG. 3B herein) utilized by the model, (iii) a third or “View/Change event exchange rules . . . ” button 526c may permit the user to view/edit event identification and/or trigger definition rules (e.g., the event exchange rules 344b of FIG. 3A herein) utilized by the model, and/or (iv) a fourth or “Composable Smart App Settings . . . ” button 526d may permit the user to view/edit settings for any applications and/or interfaces (e.g., one or more of the composable smart apps 360 and/or the data visualization interface 320 of FIG. 3A and/or FIG. 3B herein) utilized by the model.

In some embodiments, the various simulation environment action buttons/options 528a-b may be utilized by the user to change a status of a current instance of the cloud-based simulation environment. The activation of a first or “breakdown instance” button 528a may cause/trigger the current simulation environment instance to be broken down, deleted, taken offline, deactivated, etc., e.g., upon user-defined command, as opposed to automatically, and/or activation of a second or “rebuild instance” button 528b may cause/trigger the current instance of the simulation environment to be reconstructed (or constructed, in the case there is no current instance), e.g., manually, as opposed to automatically upon identification of a triggering event. In some embodiments, receiving user input via one or more of the various simulation environment action buttons/options 528a-b may comprise and/or define a triggering event.

Fewer or more components 502, 520a-b, 520-1, 520-2, 520-3, 520-4, 520-5, 522, 522-1, 522-2, 522-3, 522-4, 524, 524-1, 526, 526a-d, 528a-b and/or various configurations of the depicted components 502, 520a-b, 520-1, 520-2, 520-3, 520-4, 520-5, 522, 522-1, 522-2, 522-3, 522-4, 524, 524-1, 526, 526a-d, 528a-b may be included in the system 500 without deviating from the scope of embodiments described herein. In some embodiments, the components 502, 520a-b, 520-1, 520-2, 520-3, 520-4, 520-5, 522, 522-1, 522-2, 522-3, 522-4, 524, 524-1, 526, 526a-d, 528a-b may be similar in configuration and/or functionality to similarly named and/or numbered components as described herein. In some embodiments, the system 500 (and/or portions thereof) may comprise a dynamically-constructed cloud-based real-time (and/or near-real-time) production data processing environment simulation system and/or a platform programmed and/or otherwise configured to execute, conduct, and/or facilitate the methods/algorithms 400, 800 of FIG. 4 and/or FIG. 8 herein, and/or portions or combinations thereof.

While various components of the interfaces 520a-b have been depicted with respect to certain graphical objects, labels, layouts, headings, titles, and/or configurations, these features have been presented for reference and example only. Other graphical objects, labels, layouts, headings, titles, and/or configurations may be implemented without deviating from the scope of embodiments herein. Similarly, while a certain number of tabs, information screens, form fields, and/or data entry options may be presented and/or inferred, variations thereof may be practiced in accordance with some embodiments.

### V. Dynamically-Constructed Cloud-Based Real-Time Production Data Processing Environment Simulation Apparatus & Articles of Manufacture

Turning to FIG. 6, a block diagram of an apparatus 610 according to some embodiments is shown. In some embodiments, the apparatus 610 may be similar in configuration and/or functionality to one or more of the user devices 102a-n, 202a-c, 302, the third-party device 106, the controller devices/production systems 110a, 210a, 310a, and/or the cloud computing device/digital twin systems 110b, 210b, 310b of FIG. 1, FIG. 2, FIG. 3A, and/or FIG. 3B, herein. The apparatus 610 may, for example, execute, process, facilitate, and/or otherwise be associated with the methods/algorithms 400, 800 of FIG. 4 and/or FIG. 8 herein, and/or portions or combinations thereof. In some embodiments, the apparatus 610 may comprise a processing device 612, a communication device 614, an input device 616, an output device 618, an interface 620, a memory device 640 (storing various programs and/or instructions 642 and data 644), and/or a cooling device 650. According to some embodiments, any or all of the components 612, 614, 616, 618, 620, 640, 642, 644, 650 of the apparatus 610 may be similar in configuration and/or functionality to any similarly named and/or numbered components described herein. Fewer or more components 612, 614, 616, 618, 620, 640, 642, 644, 650 and/or various configurations of the components 612, 614, 616, 618, 620, 640, 642, 644, 650 may be included in the apparatus 610 without deviating from the scope of embodiments described herein.

According to some embodiments, the processor 612 may be or include any type, quantity, and/or configuration of processor that is or becomes known. The processor 612 may comprise, for example, an Intel® IXP 2800 network processor or an Intel® XEON™ Processor coupled with an Intel® E7501 chipset. In some embodiments, the processor 612 may comprise multiple interconnected processors, microprocessors, and/or micro-engines. According to some embodiments, the processor 612 (and/or the apparatus 610 and/or other components thereof) may be supplied power via a power supply (not shown), such as a battery, an Alternating Current (AC) source, a Direct Current (DC) source, an AC/DC adapter, solar cells, and/or generator. In the case that the apparatus 610 comprises a server, such as a blade server, necessary power may be supplied via a standard AC outlet, power strip, surge protector, and/or Uninterruptible Power Supply (UPS) device.

In some embodiments, the communication device 614 may comprise any type or configuration of communication device that is or becomes known or practicable. The communication device 614 may, for example, comprise a Network Interface Card (NIC), a telephonic device, a cellular network device, a router, a hub, a modem, and/or a communications port or cable. In some embodiments, the communication device 614 may be coupled to receive user input data, e.g., from a user device (not shown in FIG. 6). The communication device 614 may, for example, comprise a Bluetooth® Low Energy (BLE) and/or RF receiver device that acquires data from a user (not separately depicted in FIG. 6) and/or a transmitter device that provides the data to a remote server and/or server or communications layer (also not separately shown in FIG. 6). According to some embodiments, the communication device 614 may also or alternatively be coupled to the processor 612. In some embodiments, the communication device 614 may comprise an infrared (IR), RF, Bluetooth™, Near-Field Communication (NFC), and/or Wi-Fi® network device coupled to facilitate communications between the processor 612 and another device (such as a remote user device, not separately shown in FIG. 6).

In some embodiments, the input device 616 and/or the output device 618 are communicatively coupled to the processor 612 (e.g., via wired and/or wireless connections and/or pathways) and they may generally comprise any types or configurations of input and output components and/or devices that are or become known, respectively. The input device 616 may comprise, for example, a keyboard that allows an operator of the apparatus 610 to interface with the apparatus 610 (e.g., by a dynamically-constructed cloud-based real-time (and/or near-real-time) production data processing environment simulation system administrator). The output device 618 may, according to some embodiments, comprise a display screen and/or other practicable output component and/or device. The output device 618 may, for example, provide an interface (such as the interfaces 220, 320, 520a-b of FIG. 2, FIG. 3A, FIG. 3B, FIG. 5A, and/or FIG. 5B) via which functionality for dynamically-constructed cloud-based real-time (and/or near-real-time) production data processing environment simulation is provided to a user (e.g., via a website and/or mobile device application). According to some embodiments, the input device 616 and/or the output device 618 may comprise and/or be embodied in a single device, such as a touch-screen monitor.

The memory device 640 may comprise any appropriate information storage device that is or becomes known or available, including, but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of event exchange instructions 642-1, environment setup instructions 642-2, data gathering instructions 642-3, data analysis instructions 642-4, interface instructions 642-5, event data 644-1, risk data 644-2, and/or modeling data 644-3. In some embodiments, the event exchange instructions 642-1, environment setup instructions 642-2, data gathering instructions 642-3, data analysis instructions 642-4, interface instructions 642-5, event data 644-1, risk data 644-2, and/or modeling data 644-3 may be utilized by the processor 612 to provide output information via the output device 618 and/or the communication device 614.

According to some embodiments, the event exchange instructions 642-1 may be operable to cause the processor 612 to process the event data 644-1, risk data 644-2, and/or modeling data 644-3 in accordance with embodiments as described herein. Event data 644-1, risk data 644-2, and/or modeling data 644-3 received via the input device 616 and/or the communication device 614 may, for example, be analyzed, sorted, filtered, decoded, decompressed, ranked, scored, plotted, and/or otherwise processed by the processor 612 in accordance with the event exchange instructions 642-1. In some embodiments, event data 644-1, risk data 644-2, and/or modeling data 644-3 may be fed by the processor 612 through one or more mathematical and/or statistical formulas and/or models in accordance with the event exchange instructions 642-1 to identify production system events, identify triggering events, and/or to initiate and/or cause construction of a cloud-based simulation environment, as described herein.

In some embodiments, the environment setup instructions 642-2 may be operable to cause the processor 612 to process the event data 644-1, risk data 644-2, and/or modeling data 644-3 in accordance with embodiments as described herein. Event data 644-1, risk data 644-2, and/or modeling data 644-3 received via the input device 616 and/or the communication device 614 may, for example, be analyzed, sorted, filtered, decoded, decompressed, ranked, scored, plotted, and/or otherwise processed by the processor 612 in accordance with the environment setup instructions 642-2. In some embodiments, event data 644-1, risk data 644-2, and/or modeling data 644-3 may be fed by the processor 612 through one or more mathematical and/or statistical formulas and/or models in accordance with the environment setup instructions 642-2 to create, generated, stand-up, define, and/or active various components of a cloud-based simulation environment, as described herein.

According to some embodiments, the data gathering instructions 642-3 may be operable to cause the processor 612 to process the event data 644-1, risk data 644-2, and/or modeling data 644-3 in accordance with embodiments as described herein. Event data 644-1, risk data 644-2, and/or modeling data 644-3 received via the input device 616 and/or the communication device 614 may, for example, be analyzed, sorted, filtered, decoded, decompressed, ranked, scored, plotted, and/or otherwise processed by the processor 612 in accordance with the data gathering instructions 642-3. In some embodiments, event data 644-1, risk data 644-2, and/or modeling data 644-3 may be fed by the processor 612 through one or more mathematical and/or statistical formulas and/or models in accordance with the data gathering instructions 642-3 to identify, locate, query, access, copy, and/or replicate data from a plurality of sources for building and/or populating a dynamically-constructed simulation environment data store, as described herein.

In some embodiments, the data analysis instructions 642-4 may be operable to cause the processor 612 to process the event data 644-1, risk data 644-2, and/or modeling data 644-3 in accordance with embodiments as described herein. Event data 644-1, risk data 644-2, and/or modeling data 644-3 received via the input device 616 and/or the communication device 614 may, for example, be analyzed, sorted, filtered, decoded, decompressed, ranked, scored, plotted, and/or otherwise processed by the processor 612 in accordance with the data analysis instructions 642-4. In some embodiments, event data 644-1, risk data 644-2, and/or modeling data 644-3 may be fed by the processor 612 through one or more mathematical and/or statistical formulas and/or models in accordance with the data analysis instructions 642-4 to process, analyze, score, rank and/or otherwise compute and/or calculate one or more outcomes, results, responses, and/or values based on production system data and events (e.g., without taxing the underlying production system), as described herein.

According to some embodiments, the interface instructions 642-5 may be operable to cause the processor 612 to process the event data 644-1, risk data 644-2, and/or modeling data 644-3 in accordance with embodiments as described herein. Event data 644-1, risk data 644-2, and/or modeling data 644-3 received via the input device 616 and/or the communication device 614 may, for example, be analyzed, sorted, filtered, decoded, decompressed, ranked, scored, plotted, and/or otherwise processed by the processor 612 in accordance with the interface instructions 642-5. In some embodiments, event data 644-1, risk data 644-2, and/or modeling data 644-3 may be fed by the processor 612 through one or more mathematical and/or statistical formulas and/or models in accordance with the interface instructions 642-5 to generate and/or output various interface instances, environments, visualizations, and/or other interface and/or input elements, as described herein.

According to some embodiments, the apparatus 610 may comprise the cooling device 650. According to some embodiments, the cooling device 650 may be coupled (physically, thermally, and/or electrically) to the processor 612 and/or to the memory device 640. The cooling device 650 may, for example, comprise a fan, heat sink, heat pipe, radiator, cold plate, and/or other cooling component or device or combinations thereof, configured to remove heat from portions or components of the apparatus 610.

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 610. According to some embodiments, the memory device 640 may be incorporated into and/or otherwise coupled to the apparatus 610 (e.g., as shown) or may simply be accessible to the apparatus 610 (e.g., externally located and/or situated).

Referring to FIG. 7A, FIG. 7B, FIG. 7C, FIG. 7D, and FIG. 7E, perspective diagrams of exemplary data storage devices 740a-e according to some embodiments are shown. The data storage devices 740a-e may, for example, be utilized to store instructions and/or data, such as the event exchange instructions 642-1, environment setup instructions 642-2, data gathering instructions 642-3, data analysis instructions 642-4, interface instructions 642-5, event data 644-1, risk data 644-2, and/or modeling data 644-3, each of which is presented in reference to FIG. 6 herein. In some embodiments, instructions stored on the data storage devices 740a-e may, when executed by a processor, cause the implementation of and/or facilitate the methods/algorithms 400, 800 of FIG. 4 and/or FIG. 8 herein, and/or portions or combinations thereof.

According to some embodiments, the first data storage device 740a may comprise one or more various types of internal and/or external hard drives. The first data storage device 740a may, for example, comprise a data storage medium 746 that is read, interrogated, and/or otherwise communicatively coupled to and/or via a disk reading device 748. In some embodiments, the first data storage device 740a and/or the data storage medium 746 may be configured to store information utilizing one or more magnetic, inductive, and/or optical means (e.g., magnetic, inductive, and/or optical-encoding). The data storage medium 746, depicted as a first data storage medium 746a for example (e.g., breakout cross-section “A”), may comprise one or more of a polymer layer 746a-1, a magnetic data storage layer 746a-2, a non-magnetic layer 746a-3, a magnetic base layer 746a-4, a contact layer 746a-5, and/or a substrate layer 746a-6. According to some embodiments, a magnetic read head 748a may be coupled and/or disposed to read data from the magnetic data storage layer 746a-2.

In some embodiments, the data storage medium 746, depicted as a second data storage medium 746b for example (e.g., breakout cross-section “B”), may comprise a plurality of data points 746b-2 disposed with the second data storage medium 746b. The data points 746b-2 may, in some embodiments, be read and/or otherwise interfaced with via a laser-enabled read head 748b disposed and/or coupled to direct a laser beam through the second data storage medium 746b.

In some embodiments, the second data storage device 740b may comprise a CD, CD-ROM, DVD, Blu-Ray™ Disc, and/or other type of optically-encoded disk and/or other storage medium that is or becomes known or practicable. In some embodiments, the third data storage device 740c may comprise a USB keyfob, dongle, and/or other type of flash memory data storage device that is or becomes know or practicable. In some embodiments, the fourth data storage device 740d may comprise RAM of any type, quantity, and/or configuration that is or becomes practicable and/or desirable. In some embodiments, the fourth data storage device 740d may comprise an off-chip cache, such as a Level 2 (L2) cache memory device. According to some embodiments, the fifth data storage device 740e may comprise an on-chip memory device, such as a Level 1 (L1) cache memory device.

The data storage devices 740a-e depicted in FIG. 7A, FIG. 7B, FIG. 7C, FIG. 7D, and FIG. 7E are representative of a class and/or subset of computer-readable media that are defined herein as “computer-readable memory” (e.g., non-transitory memory devices as opposed to transmission devices or media). The data storage devices 740a-e may generally store program instructions, algorithms, software engines, code, models, and/or modules that, when executed by a processing device cause a particular machine to function in accordance with one or more embodiments described herein.

With reference to FIG. 8, for example, the data storage devices 740a-e may store and/or define an algorithm 800. The algorithm 800 may comprise, for example, one or more software programs, modules, models, engines, and/or applications coded to perform the method 400 of FIG. 4 herein, and/or portions thereof. The algorithm 800, and any reference to the term “algorithm” herein, refers to any set of defined instructions that operate upon input to define and/or provide output. The algorithm 800 may, for example, be specifically programmed and/or otherwise defined to instruct a computer or other device (not shown; e.g., the apparatus 610 of FIG. 6 herein) to solve a particular problem (e.g., logical) and/or resolve a particular mathematical calculation (e.g., arithmetic). In some embodiments, the algorithm 800 may be written and/or defined as a series or sequence of instructions encoded in (e.g., written in accordance with syntax and/or semantics rules) a particular computer programming language (e.g., Python™, Java™, JavaScript™, C, C++, C#, Basic™, FORTRAN, COBOL, Ruby™, and/or Perl™), e.g., a set of instructions that convert and/or encode characters, objects, and/or other data elements into machine code (e.g., code operable to be executed by an electronic processing device such as a CPU). According to some embodiments, the term “model” may refer to one or more algorithms that are coded and/or structured to utilize programming concepts and language elements to describe, represent, predict, analyze, and/or otherwise process data related to a particular problem. In some embodiments, a “model” may be specifically directed to interpreting, simulating, and/or representing a physical, mathematical, and/or computing system component, event, and/or solution. For example, a “weather model” may comprise one or more programmed algorithms that are directed to simulating likely events in the physical world—e.g., weather events.

According to some embodiments, the algorithm 800 may comprise soliciting input, at 802. Input from one or more sources may be searched for and/or queried, by structuring and/or executing a database query and/or by sending a data communication signal or “handshake”, such as is common with Bluetooth® short-range communication protocols. In some embodiments, the algorithm 800 may comprise receiving the input, at 804. Whether solicited or otherwise provided and/or acquired (e.g., loaded and/or downloaded), for example, the input for the algorithm 800 may be received, identified, and/or otherwise processed and/or located. According to some embodiments, the algorithm 800 may comprise data processing, at 812. The data processing 812 may, for example, comprise execution of one or more logical and/or computational procedures, modules, models, scripts, and/or routines that may be stored in a memory device 840 (e.g., similar to the data storage devices 740a-e) as a set of instructions or rules 842 and/or that may defined and/or implemented by one or more electrical, mechanical, and/or physical components, such as logic gates, diodes, transistors, relays, and/or switches (e.g., operable to execute the method 400 of FIG. 4 herein, and/or portions thereof).

In some embodiments, execution of the algorithm 800 may comprise a loading of the rules 842 into the memory 840 and/or into an electronic processing system (not shown) and/or an activation of one or more logic gates and/or other electrical and/or mechanical components. The algorithm 800 may operate upon the input in accordance with the rules 842 to achieve a result by defining output, at 818. The algorithm 800 may, for example, generate, produce, define, identify, calculate, and/or otherwise compute output based on an application of the data processing 812 utilizing the rules 842 and any or all input received at 804. According to some embodiments, the algorithm 800 may comprise providing the output, at 820. One or more output devices (not shown) may be utilized to convey the output (e.g., a result, conclusion, decision, etc.) to one or more other devices and/or entities (not shown), such as one or more users, consumers, customers, potential customers, and/or devices utilized thereby. The output may be displayed via an electronic display screen of a computer, mobile/smart phone, smart watch, etc., and/or may be transmitted as one or more electronic signals to one or more network destination addresses, such as e-mail addresses, URL locations, MAC addresses, and/or broadcast radio frequencies.

According to some embodiments, the data processing at 812 may comprise execution of a listing, sequence, matrix, and/or other set of stored steps and/or instructions that utilize the input to define the output. In some embodiments, the listing of steps and/or instruction details may comprise elements that are known to those skilled in the art. The algorithm 800 may partially or completely comprise, for example, instructions and/or steps that are well known, such as steps and/or instructions operable to calculate an area (length times width), volume (length times width times height), distance (difference between two locations), velocity (distance over time), acceleration (velocity over time), and/or any other known mathematical and/or logical (if/then statements) procedures. For any and all known procedures and/or instructions, the discrete details of such instructions are represented by the data processing at 812 and are not listed herein as one of ordinary skill in the art would readily comprehend both what such technological knowledge entails and that the inventor has possession of such knowledge. Instructions that may be included within and/or comprise the data processing at 812 (and/or the algorithm 800) may include, for example, but are not limited to, any known or practicable: (i) OCR algorithms, (ii) GUI object behavior algorithms, (iii) data transmission algorithms, (iv) data encoding algorithms, (v) data decoding algorithms, (vii) logical and/or mathematical data comparison algorithms, (viii) data searching (e.g., keyword searching) algorithms, and/or (ix) any algorithms developed by (e.g., as a result of) application of training data sets to “teach” an AI/ML model how to process data.

### VI. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The indefinite articles “a” and “an,” as used herein in the specification and in the claims, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “program” or “computer program” may refer to one or more algorithms formatted for execution by a computer. The term “module” or “software module” refers to any number of algorithms, models, and/or programs that are written to achieve a particular output and/or output goal—e.g., a ‘login credentialing’ module (or program) may provide functionality for permitting a user to login to a computer software and/or hardware resource and/or a ‘shipping’ module (or program) may be programmed to electronically initiate a shipment of an object via a known and/or available shipping company and/or service (e.g., FedEX®). The terms “engine” or “software engine” refer to any combination of software modules and/or algorithms that operate upon one or more inputs to define one or more outputs in an ongoing, cyclical, repetitive, and/or loop fashion. Data transformation scripts and/or algorithms that query data from a data source, transform the data, and load the transformed data into a target data repository may be termed ‘data transformation engines’, for example, as they repetitively operate in an iterative manner upon each row of data to produce the desired results.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. A system for real-time data analysis of production data utilizing a dynamically-constructed cloud-based simulation environment, comprising:
an event exchange layer in communication with an event publishing layer of a production data processing system, the event exchange layer comprising:
a plurality of event listeners, each event listener being programmed to identify an occurrence of an event in one of a plurality of production environment systems and each event listener being communicatively coupled to receive event data from the respective one of the plurality of production environment systems via the event publishing layer of the production data processing system; and
a real-time data analysis system comprising:
a processing device; and
a non-transitory memory device in communication with the processing device, the non-transitory memory device storing (i) rules and (ii) instructions, that when executed by the processing device result in:
identifying, by a first event listener from the plurality of event listeners, a first event from a respective first production environment system of the plurality of production environment systems;
determining, by an application of the stored rules and based on data descriptive of the first event, that the first event comprises a simulation environment build trigger;
constructing, dynamically and in response to the determining that the first event comprises the simulation environment build trigger, an instance of a cloud-based simulation environment, wherein the instance of the cloud-based simulation environment, comprises:
a plurality of data storage elements;
at least one data analysis model element; and
at least one composable smart app element;
analyzing, by executing the at least one data analysis model element, data stored in the plurality of data storage elements in relation to the first event;
generating, based on the analyzing, a response to the first event;
publishing, via the at least one composable smart app element, the response to the first event; and
deconstructing, dynamically and in response to the publishing, the instance of the cloud-based simulation environment.

2. The system for real-time data analysis of production data utilizing the dynamically-constructed cloud-based simulation environment of claim 1, wherein the identifying of the first event by the first event listener comprises:
receiving an indication of a transmission of the data descriptive of the first event from the first production environment system to a client device destination; and
intercepting the transmission of the data descriptive of the first event.

3. The system for real-time data analysis of production data utilizing the dynamically-constructed cloud-based simulation environment of claim 2, wherein the publishing of the response to the first event comprises:
transmitting an indication of the response to the first event to the client device destination.

4. The system for real-time data analysis of production data utilizing the dynamically-constructed cloud-based simulation environment of claim 1, wherein the at least one data analysis model element comprises an Artificial Intelligence (AI) model.

5. The system for real-time data analysis of production data utilizing the dynamically-constructed cloud-based simulation environment of claim 1, wherein the at least one data analysis model element comprises a Machine Learning (ML) model.

6. The system for real-time data analysis of production data utilizing the dynamically-constructed cloud-based simulation environment of claim 1, wherein the at least one data analysis model element comprises a graph model.

7. The system for real-time data analysis of production data utilizing the dynamically-constructed cloud-based simulation environment of claim 1, wherein the at least one data analysis model element comprises a model-as-a-service model.

8. The system for real-time data analysis of production data utilizing the dynamically-constructed cloud-based simulation environment of claim 1, wherein the at least one data analysis model element comprises a plurality of models that are evaluated utilizing a champion-challenger technique.

9. The system for real-time data analysis of production data utilizing the dynamically-constructed cloud-based simulation environment of claim 1, wherein the at least one data analysis model element comprises a plurality of models that are evaluated utilizing an A/B testing technique.

10. The system for real-time data analysis of production data utilizing the dynamically-constructed cloud-based simulation environment of claim 1, wherein the at least one composable smart app element comprises an Application Programming Interface (API).

11. A method for real-time data analysis of production data utilizing a dynamically-constructed cloud-based simulation environment, comprising:
identifying, by a first event listener from a plurality of event listeners of an event exchange layer, wherein each event listener is programmed to identify an occurrence of an event in one of a plurality of production environment systems and each event listener is communicatively coupled to receive event data from the respective one of the plurality of production environment systems via an event publishing layer of a production data processing system, a first event from a respective first production environment system of the plurality of production environment systems;
determining, by an application of stored rules stored by a non-transitory memory device in communication with a processing device of a real-time data analysis system, by the processing device and based on data descriptive of the first event, that the first event comprises a simulation environment build trigger;
constructing, dynamically, by the processing device and in response to the determining that the first event comprises the simulation environment build trigger, an instance of a cloud-based simulation environment, wherein the instance of the cloud-based simulation environment, comprises:
a plurality of data storage elements;
at least one data analysis model element; and
at least one composable smart app element;
analyzing, by executing the at least one data analysis model element by the processing device, data stored in the plurality of data storage elements in relation to the first event;
generating, by the processing device and based on the analyzing, a response to the first event;
publishing, via the at least one composable smart app element, the response to the first event; and
deconstructing, dynamically, by the processing device and in response to the publishing, the instance of the cloud-based simulation environment.

12. The method for real-time data analysis of production data utilizing a dynamically-constructed cloud-based simulation environment of claim 11, wherein the identifying of the first event by the first event listener comprises:
receiving an indication of a transmission of the data descriptive of the first event from the first production environment system to a client device destination; and
intercepting the transmission of the data descriptive of the first event.

13. The method for real-time data analysis of production data utilizing a dynamically-constructed cloud-based simulation environment of claim 12, wherein the publishing of the response to the first event comprises:
transmitting an indication of the response to the first event to the client device destination.

14. The method for real-time data analysis of production data utilizing a dynamically-constructed cloud-based simulation environment of claim 11, wherein the at least one data analysis model element comprises an Artificial Intelligence (AI) model.

15. The method for real-time data analysis of production data utilizing a dynamically-constructed cloud-based simulation environment of claim 11, wherein the at least one data analysis model element comprises a Machine Learning (ML) model.

16. The method for real-time data analysis of production data utilizing a dynamically-constructed cloud-based simulation environment of claim 11, wherein the at least one data analysis model element comprises a graph model.

17. The method for real-time data analysis of production data utilizing a dynamically-constructed cloud-based simulation environment of claim 11, wherein the at least one data analysis model element comprises a model-as-a-service model.

18. The method for real-time data analysis of production data utilizing a dynamically-constructed cloud-based simulation environment of claim 11, wherein the at least one data analysis model element comprises a plurality of models that are evaluated utilizing a champion-challenger technique.

19. The method for real-time data analysis of production data utilizing a dynamically-constructed cloud-based simulation environment of claim 11, wherein the at least one data analysis model element comprises a plurality of models that are evaluated utilizing an A/B testing technique.

20. The method for real-time data analysis of production data utilizing a dynamically-constructed cloud-based simulation environment of claim 11, wherein the at least one composable smart app element comprises an Application Programming Interface (API).
